(19) United States
(12) Patent Application Publication
(10) Pub. No.: US 2026/0252208 A1
(43) Pub. Date: Aug. 27, 2026

(54) SYSTEM

(71) Applicant: SoftBank Group Corp., Tokyo (JP)

(72) Inventor: Hiroshi NAKAMURA, Tokyo (JP)

(73) Assignee: SoftBank Group Corp., Tokyo (JP)

(21) Appl. No.: 19/533,333

(22) Filed: Feb. 9, 2026

(30) Foreign Application Priority Data
Feb. 21, 2025 (JP) 2025-027059

(51) Int. Cl. G06F 3/0482; G06F 3/04842; H04N 21/414

(52) U.S. Cl. CPC G06F 3/0482; G06F 3/04842; H04N 21/41407

(57) ABSTRACT

The system according to the embodiment comprises a connection unit, a startup unit, and an operation unit. The connection unit connects a mobile terminal equipped with a USB-type messenger application to a USB port of a television. The startup unit recognizes the terminal connected by the connection unit and launches the messenger application. The operation unit operates the messenger application launched by the startup unit using a remote controller.

### CROSS-REFERENCE TO RELATED APPLICATION

The present application claims priority to and incorporates by reference the entire contents of Japanese Patent Application No. 2025-027059 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that elderly persons who find it difficult to read small characters on smartphones have difficulty using messenger applications.

### SUMMARY OF THE INVENTION

The system according to the embodiment comprises a connection unit, a startup unit, and an operation unit. The connection unit connects a mobile terminal equipped with a USB-type messenger application to a USB port of a television. The startup unit recognizes the terminal connected by the connection unit and launches the messenger application. The operation unit operates the messenger application launched by the startup unit using a remote controller.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

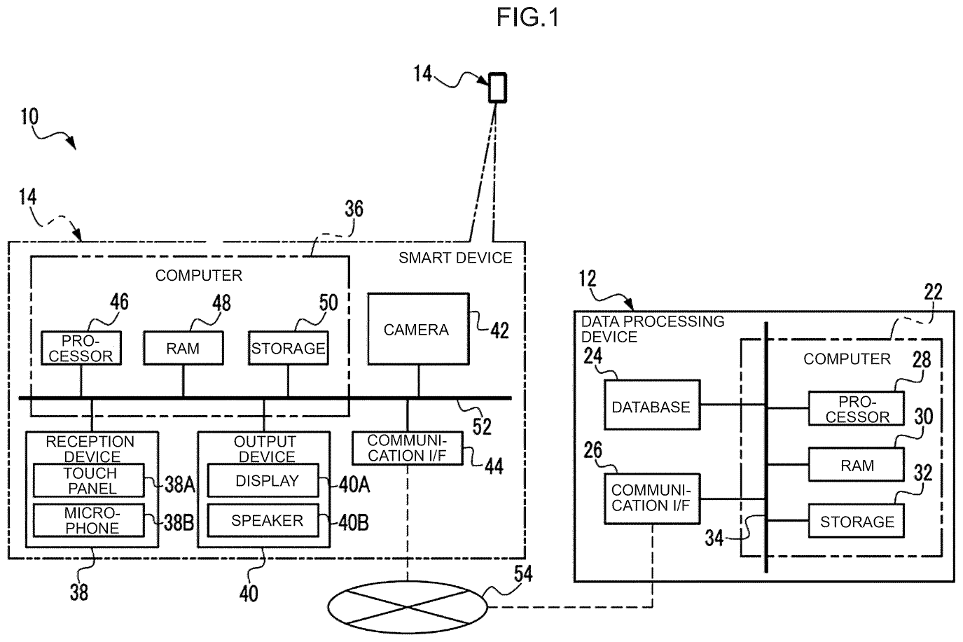

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

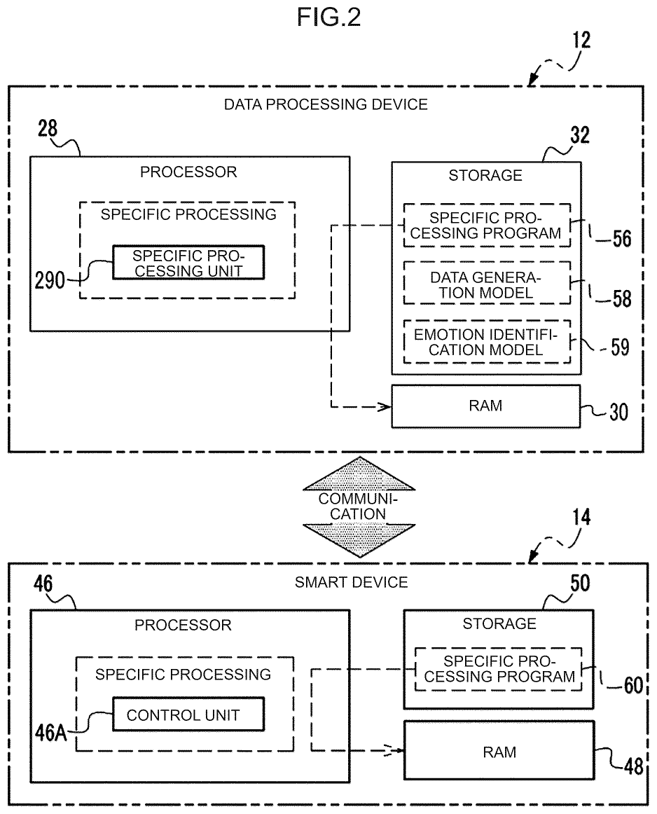

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The communication system according to the embodiment of the present invention is a system that enables the use of a messenger application on a home television. This communication system allows the television to function as a communication terminal by connecting a mobile terminal equipped with a USB-type messenger application to the USB port of the television. Specifically, the user prepares a mobile terminal equipped with a USB-type messenger application and inserts it into the USB port of the television. As a result, the television automatically recognizes and launches the messenger application. The interface of the messenger application is displayed on the television screen, and the user can operate the messenger application using a remote controller. For example, it is possible to send and receive messages, share photos or videos, and conduct video calls. In particular, for elderly persons, the ability to read messages on the large television screen allows comfortable use even when it is difficult to read small text on a smartphone. Furthermore, this system can also meet the demand for monitoring. For example, family members or caregivers can regularly conduct video calls with elderly persons to confirm their safety and check their health status. In emergencies, rapid contact can be made through the messenger application. Thus, by connecting a mobile terminal equipped with a USB-type messenger application to the television, the television functions as a communication terminal and meets the demand for communication means and monitoring with elderly persons. As a result, the communication system can meet the demand for communication means and monitoring with elderly persons. Specifically, this communication system utilizes the hardware resources of the television (CPU, memory, GPU, etc.) and collaborates with the storage and computational resources of the mobile terminal equipped with the messenger application connected via USB to perform automatic application recognition, launching, UI rendering, and user interaction processing. The television firmware analyzes the vendor ID, product ID, file system structure, and application signature information of the USB device to detect the presence of a predetermined messenger application. Upon detection, a dedicated application launcher is started on the television OS, and executable files and resource files on the USB storage are loaded into memory. The user interface is automatically generated by a layout engine optimized for the television's resolution and screen size, and input signals from the remote controller (infrared or Bluetooth protocol) are received by an event handler and mapped to various application functions (message sending and receiving, media sharing, video calls, etc.). For the message sending and receiving function, the television's network interface (Wi-Fi or wired LAN) establishes encrypted communication (such as TLS) with a messenger server on the Internet, and exchanges text data and image/video files (JPEG, PNG, MP4, etc.). For the video call function, video and audio streams obtained from external camera and microphone devices connected to the television are encoded in real time (H.264, AAC, etc.) and P2P communication is performed with the other terminal using protocols such as WebRTC. UI optimization for elderly persons includes automatic font size enlargement, contrast enhancement, voice reading function, and one-touch operation mode. For monitoring purposes, features such as regular video call scheduling, automatic display of health checklists, and constant display of emergency call buttons are incorporated. As a technical effect, this communication system greatly improves visibility, operability, and accessibility by utilizing the large screen and high-performance device of the television, without relying on conventional smartphones or tablet terminals, and realizes immediate application deployment, portability of user profiles, and enhanced security (prevention of information leakage when the terminal is not connected) through attachment and detachment of USB devices. In addition, AI processing utilizing the computational resources of the television (e.g., speech recognition, face authentication, emotion estimation) and efficient use of network bandwidth (media compression, streaming optimization) are also possible. Application fields include monitoring of elderly persons, remote medical care, family communication, educational support, and support for persons with disabilities. Through these configurations and processes, the present invention not only automates human tasks but also brings about expansion of communication functions of television terminals, improvement of user experience, and technical advancement of the entire system.

The communication system according to the embodiment comprises a connection unit, a startup unit, and an operation unit. The connection unit connects a mobile terminal equipped with a USB-type messenger application to a USB port of a television. For example, the connection unit may use a port compatible with USB 2.0 or USB 3.0 standards. The startup unit recognizes the terminal connected by the connection unit and launches the messenger application. For example, the startup unit may automatically detect the connected terminal and launch the messenger application using software incorporated in the television's firmware. The operation unit operates the messenger application launched by the startup unit using a remote controller. For example, the operation unit may use an infrared remote controller or a Bluetooth remote controller to operate the interface of the messenger application. The operation unit provides functions such as sending and receiving messages, sharing photos or videos, and video calls. As a result, the communication system can use the television as a communication terminal and meet the demand for communication means and monitoring with elderly persons. Specifically, this communication system utilizes the hardware resources of the television (CPU, memory, GPU, etc.) and collaborates with the storage and computational resources of the mobile terminal equipped with the messenger application connected via USB to perform automatic application recognition, launching, UI rendering, and user interaction processing. The connection unit of this communication system acquires vendor ID, product ID, file system structure, and application signature information of the USB device as byte sequences and is equipped with a dedicated device driver module to parse these. For example, data acquired from the USB device includes a 16-byte vendor ID, a 16-byte product ID, a FAT32 or exFAT format file system structure, and an application binary signed with SHA-256. The startup unit determines whether a predetermined messenger application is stored based on this information, and the determination algorithm combines signature verification (public key cryptography), file hash matching, and application version checking. The startup unit launches a dedicated application launcher on the television OS and loads executable files and resource files (images, audio, UI definition XML, etc.) from the USB storage into memory. The operation unit receives input signals from the television remote controller (infrared or Bluetooth protocol) via an event handler and maps them to various application functions (message sending and receiving, media sharing, video calls, etc.). For example, a “confirm” button press event on the remote controller is assigned to the “send” button on the UI, and cursor movement is used for UI element focus control. For the message sending and receiving function, the television's network interface (Wi-Fi or wired LAN) establishes encrypted communication (such as TLS 1.3) with a messenger server on the Internet and exchanges text data (UTF-8 encoded), image files (JPEG, PNG), and video files (MP4, H.264/AAC). For the video call function, video and audio streams obtained from external camera and microphone devices connected to the television are encoded in real time and P2P communication is performed with the other terminal using the WebRTC protocol. The UI rendering engine automatically generates layouts according to the television's resolution and screen size and implements accessibility features such as automatic font size enlargement, contrast enhancement, voice reading function, and one-touch operation mode. For monitoring purposes, features such as regular video call scheduling, automatic display of health checklists, and constant display of emergency call buttons are incorporated. As a technical effect, this communication system greatly improves visibility, operability, and accessibility by utilizing the large screen and high-performance device of the television, without relying on conventional smartphones or tablet terminals, and realizes immediate application deployment, portability of user profiles, and enhanced security (prevention of information leakage when the terminal is not connected) through attachment and detachment of USB devices. In addition, AI processing utilizing the computational resources of the television (e.g., speech recognition, face authentication, emotion estimation) and efficient use of network bandwidth (media compression, streaming optimization) are also possible. Application fields include monitoring of elderly persons, remote medical care, family communication, educational support, and support for persons with disabilities. Through these configurations and processes, the present invention not only automates human tasks but also brings about expansion of communication functions of television terminals, improvement of user experience, and technical advancement of the entire system.

The operation unit is capable of sending and receiving messages. The operation unit can, for example, send and receive text messages and voice messages. For example, the operation unit can use a remote controller to input and send text messages. In addition, the operation unit can use a voice input function to record and send voice messages. Thus, the operation unit enables sending and receiving messages. Specifically, the operation unit receives input signals from the television remote controller and, in the case of text messages, generates UTF-8 encoded string data using cursor movement and character input buttons on the remote controller. For voice messages, the operation unit acquires a 16 kHz, 16 bit PCM format audio stream from a microphone device connected to the television, applies noise reduction and audio compression (e.g., AAC, Opus) as needed, and generates a transmission packet as binary data. The operation unit transmits these message data to the messenger server via the television's network interface (Wi-Fi or wired LAN) using encrypted protocols such as TLS 1.3. Upon reception, text data and audio data received from the server are decrypted, rendered on the screen in the case of text, and played through the television speakers in the case of audio. When AI processing is incorporated, the operation unit can use a speech recognition engine (e.g., convolutional neural network or Transformer-based speech recognition model) to convert voice input into text in real time and automatically convert and send the content input by the user as a text message. Examples of AI input include one-dimensional audio waveform arrays (float array of length 16000 for one second) or text token sequences (e.g., “Hello, how are you?”). Examples of AI output include recognized text sequences (“Hello, how are you?”) or emotion labels (“joy,” “sadness,” etc.). These outputs are used for subsequent processing such as automatic classification of transmitted messages or optimization of transmission timing (e.g., delaying transmission when the user is nervous). As a technical effect, the operation unit can greatly improve the efficiency, accuracy, and security of message sending and receiving by combining speech recognition, AI-assisted input, encrypted communication, and real-time conversion processing compared to conventional simple remote control operation or manual input by humans. Application fields include communication support for elderly persons and persons with disabilities, remote medical care, use of voice messages in educational settings, and diverse message exchange among family members. Through these configurations, the operation unit goes beyond mere automation of human tasks and can technologically enhance the communication functions of television terminals and revolutionize the user experience.

The operation unit is capable of sharing photos or videos. The operation unit can, for example, share photos in JPEG format or videos in MP4 format. For example, the operation unit can use a remote controller to select and share photos or videos. In addition, the operation unit can display photos or videos on the television screen and share them with other users. Thus, the operation unit enables sharing of photos or videos. Specifically, the operation unit acquires a list of media files on the television's storage or USB device using a file system API, and for JPEG files, decodes RGB image data (e.g., 1920×1080×3 uint 8 array), and for MP4 files, decodes video and audio streams encoded with H.264/AAC for preview display. Files selected by the user with the remote controller undergo buffering, are divided and compressed according to network bandwidth (e.g., adjusting JPEG compression rate for images, bitrate control for videos), and are uploaded to the messenger server via encrypted communication channels such as TLS. On the receiving side, image and video data downloaded from the server are decrypted and decoded, and displayed on the television screen in full screen or as thumbnails. When AI processing is incorporated, the operation unit can use image recognition models (e.g., ResNet, EfficientNet CNNs) or video analysis models (e.g., 3D-CNN, Transformer-based time series analysis models) to automatically classify the content of photos or videos (e.g., person, landscape, food) or automatically detect inappropriate content (e.g., blurring, warning display). Examples of AI input include 224×224×3 image tensors or 16 frames×224×224×3 video tensors. Examples of AI output include category labels (“person,” “landscape,” etc.), inappropriate content scores (0.0-1.0), and thumbnail image generation. These outputs are used for subsequent processing such as automatic filtering before sharing, recommendation display to recipient users, and optimization of sharing timing (e.g., delaying or expediting sharing according to user emotion or usage status). As a technical effect, the operation unit can greatly improve the convenience, safety, and efficiency of photo and video sharing by combining AI-based content analysis, automatic classification, security enhancement, and network optimization compared to conventional simple file transfer. Application fields include sharing family memories, image diagnosis support in remote medical care, distribution of educational videos in educational settings, and image-to-speech conversion for support of persons with disabilities. Through these configurations, the operation unit goes beyond mere automation of human tasks and can technologically enhance the media sharing functions of television terminals and revolutionize the user experience.

The operation unit is capable of performing video calls. The operation unit can, for example, use video call technologies such as WebRTC and H.264 to conduct video calls. For example, the operation unit can use a remote controller to initiate a video call and exchange video and audio with the other party in real time. In addition, the operation unit can operate the interface displayed on the screen during a video call and change call settings. Thus, the operation unit enables video calls. Specifically, the operation unit acquires a 30 fps, 720 p or 1080 p RGB video stream from a camera device connected to the television and a 16 kHz, 16 bi PCM audio stream from a microphone device. These streams are encoded in real time using H.264 (video) and AAC or Opus (audio) codecs and transmitted to the other terminal via P2P or server relay using the WebRTC protocol. On the receiving side, the decoded video and audio are played on the television screen and speakers. The operation unit can use remote controller input to change call settings in real time, such as starting/ending calls, muting the microphone, switching cameras, and changing screen layout (e.g., picture-in-picture, full screen display). When AI processing is incorporated, the operation unit can use face recognition models (e.g., FaceNet, ArcFace) and emotion estimation models (e.g., CNN+LSTM, multimodal Transformer) to estimate the emotional state (e.g., joy, surprise, sadness) of the user from facial expressions and voice during the call, and automatically adjust the call interface (e.g., change background color, display emotion icons) or optimize call quality (e.g., automatically adjust resolution during network delay). Examples of AI input include face image tensors (112×112×3), audio spectrograms (128×128 float array), and time series frame sequences (face feature vectors for 10 frames). Examples of AI output include emotion labels (“joy,” “surprise,” etc.), call quality scores (0.0-1.0), and recommended UI settings (“bright background,” “mute recommended,” etc.). These outputs are used for subsequent processing such as automatic interface adjustment during calls, feedback display to users, and automatic optimization of call quality. As a technical effect, the operation unit can greatly improve the comfort, safety, and accessibility of the call experience by combining AI-based emotion estimation, face recognition, quality optimization, and automatic UI adjustment compared to conventional simple video calls. Application fields include monitoring of elderly persons, support for remote medical examinations, remote classes in educational settings, and expression recognition calls for support of persons with disabilities. Through these configurations, the operation unit goes beyond mere automation of human tasks and can technologically enhance the video call functions of television terminals and revolutionize the user experience.

The operation unit is capable of displaying messages on a large television screen. The operation unit can, for example, display messages on a 32-inch or 4K resolution television screen. For example, the operation unit can use a remote controller to input messages and display them on the large television screen. In addition, the operation unit can adjust the font size and display position of messages. Thus, by displaying messages on a large television screen, the operation unit enables comfortable use for elderly persons. Specifically, the operation unit uses the television's display driver API to render received text messages (UTF-8 encoded strings) in a layout optimized for the screen resolution (e.g., 3840×2160 pixels). Font size is determined based on user settings or automatic judgment (e.g., 48 pt or larger in elderly mode) and displayed with anti-aliasing processing for high contrast. Display position can be selected from the center, bottom, sidebar, etc., and automatic placement by remote controller operation or AI (e.g., avoiding overlap with other UI elements) is also possible. When AI processing is incorporated, the operation unit can use a user gaze detection model (e.g., CNN+regression model) or emotion estimation model to estimate in real time which part of the screen the user is focusing on or which display style is most comfortable, and automatically adjust font size, color, and placement. Examples of AI input include camera images (640×480×3), facial landmark coordinates (68 points of 2D coordinate arrays), and past display history data (display position, size, user response score, etc.). Examples of AI output include recommended font size (e.g., 56 pt), recommended display position (“center,” “bottom,” etc.), and recommended color scheme (“high contrast,” etc.). These outputs are used for subsequent processing such as automatic setting of the display engine, customization proposals to users, and accessibility optimization. As a technical effect, the operation unit can greatly improve visibility, operability, and accessibility by combining AI-based gaze detection, emotion estimation, and automatic layout adjustment compared to conventional fixed message display. Application fields include information display for elderly persons and visually impaired persons, large screen teaching material presentation in educational settings, instruction display in remote medical care, and large screen communication among family members. Through these configurations, the operation unit goes beyond mere automation of human tasks and can technologically enhance the display functions of television terminals and revolutionize the user experience.

The operation unit enables family members or caregivers to regularly (for example, once a week) conduct video calls with elderly persons to confirm their safety and check their health status. The operation unit can, for example, set a schedule to conduct video calls every Monday at 10:00 a.m. For example, the operation unit can use a remote controller to set the schedule for video calls and conduct them regularly. In addition, the operation unit can check the health status of elderly persons during video calls and notify family members or caregivers as needed. Thus, the operation unit makes it easy to confirm the safety and check the health status of elderly persons. Specifically, the operation unit incorporates a scheduler module and saves the day and time information specified by the user with the remote controller (e.g., every Monday at 10:00) as a calendar data structure (ISO 8601 format). When the scheduled time arrives, the operation unit automatically activates the video call function and establishes a connection with pre-registered family or caregiver terminals using the WebRTC protocol. During the call, the operation unit acquires camera video and audio streams in real time and uses AI-based health status estimation models (e.g., facial color analysis CNN, voice anomaly detection RNN) to automatically extract health indicators (e.g., facial color score, speech rate, cough detection) from the facial expressions, voice tone, and speech content of the elderly person. Examples of AI input include face image tensors (112×112×3), audio spectrograms (128×128), and time series speech text sequences (e.g., “Hello, I am fine”). Examples of AI output include health status labels (“good,” “caution,” “contact required”), anomaly detection scores (0.0-1.0), and automatic notification triggers (“notify family,” etc.). These outputs are used for subsequent processing such as automatic report generation after the call, push notifications to family members or caregivers, and automatic adjustment of the next call schedule. As a technical effect, the operation unit can greatly improve the efficiency, accuracy, and responsiveness of monitoring by combining AI-based automatic analysis, scheduling, anomaly detection, and notification linkage compared to conventional manual safety confirmation and health checks. Application fields include monitoring of elderly persons, health monitoring in remote medical care, support for persons with disabilities, and automation of home care. Through these configurations, the operation unit goes beyond mere automation of human tasks and can technologically enhance the monitoring functions of television terminals and revolutionize the user experience.

The connection unit is capable of estimating a user's emotion and adjusting the timing of the connection based on the estimated emotion. The connection unit can, for example, estimate a user's emotion using facial recognition or voice analysis. For example, the connection unit can capture the user's facial expression with a camera and estimate the emotion using an emotion estimation algorithm. In addition, the connection unit can record the user's voice with a microphone and estimate the emotion using voice analysis technology. Thus, the connection unit can adjust the timing of the connection according to the user's emotion. Emotion estimation is realized, for example, by using an emotion engine or generative AI for emotion estimation functions. Generative AI may include text generation AI (e.g., LLM) or multimodal generative AI, but is not limited to these examples. For example, if the user is relaxed, the connection unit may delay the timing of the connection to provide the user with time to prepare. If the user is in a hurry, the connection unit may expedite the timing of the connection for rapid connection. Furthermore, if the user feels anxious, the connection unit may adjust the timing of the connection to ensure the user feels secure. Thus, by adjusting the timing of the connection according to the user's emotion, the connection unit enables more appropriate connections. Specifically, the connection unit acquires facial images (e.g., 112×112×3 RGB tensor) obtained from a camera device connected to the television and audio waveform data (e.g., 16 kHz, 16 bit PCM format, 16,000 samples per second float array) obtained from a microphone device as input data. The connection unit extracts facial features and audio features (e.g., MFCC, spectrogram) from these input data using convolutional neural networks (CNN) and time series analysis models (e.g., LSTM, Transformer-based voice emotion recognition models). The connection unit inputs the extracted features into a multilayer perceptron or multimodal fusion network and outputs emotion labels (e.g., “relaxed,” “nervous,” “anxious,” “in a hurry”) and emotion scores (continuous values from 0.0 to 1.0). For example, a “relaxed” label may be output from the facial image and a “nervous” score of 0.8 from the audio. The connection unit inputs these output values into a threshold judgment logic or rule-based engine and determines specific timing adjustment parameters, such as “if nervous score is 0.7 or higher, delay connection by 5 seconds,” “if relaxed, proceed as usual.” Furthermore, the connection unit can collaborate with a database of past emotion estimation history and connection success rates for individualized optimization (personalization). For AI model training, cross-entropy loss functions and Adam optimizers are used, and pre-training is performed on datasets of thousands to tens of thousands of facial images and audio data. As a technical effect, the connection unit realizes real-time and highly accurate connection timing control based on emotion estimation, without relying on conventional simple timers or manual user operations, thereby reducing psychological burden on users and decreasing connection failures and stress. Application fields include optimization of safety confirmation calls in elderly monitoring systems, connection control according to patient psychological state in remote medical care, communication initiation control according to concentration level in educational support terminals, and provision of stress-free connection experiences in support terminals for persons with disabilities. Through these configurations and processes, the connection unit goes beyond mere automation of human tasks and can technologically enhance the communication control functions of television terminals and revolutionize the user experience.

The connection unit is capable of detecting the usage status of the television at the time of connection and selecting an appropriate connection timing. The connection unit can, for example, detect the power on/off status of the television and the current input source. For example, if the television is using another application, the connection unit may delay the connection and wait for the application to finish. If the television is powered off, the connection unit may wait until the power is turned on before connecting. Furthermore, if the television is recording, the connection unit may delay the connection until the recording is finished. Thus, by selecting the optimal connection timing according to the usage status of the television, the connection unit improves connection efficiency. Specifically, the connection unit acquires status information such as power state (ON/OFF), input source type (HDMI, USB, AV, etc.), currently running application ID, and recording process status (recording/not recording) every second via the television's system API, either by polling or event-driven methods. The connection unit manages the acquired status information as bit flags or structures (e.g., {power: 1, input: HDMI, app: recording, rec: 1}) and uses a state transition detection algorithm (e.g., state transition graph, priority queue) to determine connection conditions (e.g., power ON, not recording, no application in use). If the conditions are not met, the connection unit re-evaluates at regular intervals and executes connection processing (USB device recognition, application launch, etc.) only when the conditions are satisfied. Furthermore, the connection unit can hook recording end events or application termination events to immediately resume connection processing. When AI processing is incorporated, the connection unit can learn past television usage history (e.g., recording frequency by day and time, application usage patterns) as time series data and use a time series prediction model (e.g., LSTM, Transformer) to predict optimal connection timing. Examples of AI input include a binary vector of recording/application usage flags for each hour over the past 7 days (168 dimensions), and a current system state vector (4 dimensions). Examples of AI output include recommended connection timing (e.g., after 19:00 today), connection success probability score (0.0-1.0), and connection wait recommendation flag (1/0). These outputs are used for subsequent processing such as automatic control of the connection scheduler, connection wait notifications to users, and reduction of connection failure risk. As a technical effect, the connection unit can optimize connection timing, reduce connection failure rates, and improve user experience by combining real-time television usage status, history analysis, and AI prediction, compared to conventional simple timers or manual user operations. Application fields include communication control for home television terminals, automatic connection for remote medical terminals, optimization of teaching material distribution timing in educational settings, and automatic connection control for support terminals for persons with disabilities. Through these configurations, the connection unit goes beyond mere automation of human tasks and can technologically enhance the connection control functions of television terminals and revolutionize the efficiency and reliability of the entire system.

The connection unit is capable of performing filtering to avoid interference with other connected devices of the television at the time of connection. The connection unit can, for example, perform filtering to avoid Wi-Fi or Bluetooth interference. For example, if other USB devices are connected, the connection unit may adjust the connection to avoid interference with those devices. If HDMI devices are connected, the connection unit may also adjust the connection to avoid interference with those devices. Furthermore, if Bluetooth devices are connected, the connection unit may also adjust the connection to avoid interference with those devices. Thus, by avoiding interference with other connected devices, the connection unit improves connection stability. Specifically, the connection unit acquires the connection status of USB ports (e.g., device ID for each port, bus power consumption), HDMI port connection status (EDID information, resolution, bandwidth usage), and Wi-Fi/Bluetooth module channel usage status (2.4 GHz/5 GHz channel number, RSSI value, connected device MAC address) in real time using the television's hardware abstraction layer API. The connection unit manages this information as a device management table (e.g., a structure storing the type, status, and priority of each device) and executes interference determination algorithms (e.g., channel overlap detection, bus power overuse detection, bandwidth competition determination). For example, if Wi-Fi and Bluetooth are using the same 2.4 GHz channel, Bluetooth connection is temporarily suspended, and if USB devices exceed the bus power limit, new connections are delayed. When AI processing is incorporated, the connection unit can learn from past device interference history (e.g., device combinations at connection failure, channel usage status, error codes) as training data and use a classification model (e.g., random forest, LightGBM, DNN) to predict the probability of interference occurrence. Examples of AI input include current device connection state vectors (USB: 4 bits, HDMI: 2 bits, Wi-Fi: 8 bits, Bluetooth: 8 bits, etc.), and a 24-dimensional array of interference occurrence flags over the past 24 hours. Examples of AI output include interference risk score (0.0-1.0), recommended connection timing (e.g., 5 seconds later), and priority connection device ID (e.g., USB1). These outputs are used for subsequent processing such as automatic control of the connection scheduler, connection order proposals to users, and automatic reconnection processing to avoid interference. As a technical effect, the connection unit can greatly improve connection stability, communication quality, and user experience by combining real-time hardware status monitoring, AI-based interference prediction, and automatic filtering, compared to conventional simple device connection control. Application fields include multi-device connection control for home television terminals, communication stabilization for remote medical terminals, simultaneous use of multiple terminals in educational settings, and reliability improvement for support terminals for persons with disabilities. Through these configurations, the connection unit goes beyond mere automation of human tasks and can technologically enhance the device connection management functions of television terminals and revolutionize the stability and reliability of the entire system.

The connection unit is capable of estimating a user's emotion and determining the priority of the connection based on the estimated emotion. The connection unit can, for example, estimate a user's emotion using facial recognition or voice analysis. For example, the connection unit can capture the user's facial expression with a camera and estimate the emotion using an emotion estimation algorithm. In addition, the connection unit can record the user's voice with a microphone and estimate the emotion using voice analysis technology. Thus, the connection unit can determine the priority of the connection according to the user's emotion. Emotion estimation is realized, for example, by using an emotion engine or generative AI for emotion estimation functions. Generative AI may include text generation AI (e.g., LLM) or multimodal generative AI, but is not limited to these examples. For example, if the user feels stressed, the connection unit sets a high priority for the connection and connects quickly. If the user is relaxed, the connection unit sets a low priority and may prioritize other tasks. Furthermore, if the user is in a hurry, the connection unit sets a high priority and connects quickly. Thus, by determining the priority of the connection according to the user's emotion, the connection unit enables more appropriate connections. Specifically, the connection unit acquires facial images (112×112×3 RGB tensor) obtained from a camera device connected to the television and audio waveform data (16 kHz, 16 bit PCM format, 16,000 samples per second float array) obtained from a microphone device as input data. The connection unit extracts facial features and audio features (MFCC, spectrogram) from these input data using convolutional neural networks (CNN) and time series analysis models (LSTM, Transformer-based voice emotion recognition models). The connection unit inputs the extracted features into a multilayer perceptron or multimodal fusion network and outputs emotion labels (“stress,” “relaxed,” “in a hurry”) and emotion scores (continuous values from 0.0 to 1.0), as well as recommended priority values (1 to 5 levels). Examples of AI input include face image tensors (112×112×3), audio spectrograms (128×128 float array), and multimodal feature vectors (concatenated face and voice vectors). Examples of AI output include emotion labels (“stress,” “relaxed,” “in a hurry”), emotion scores (e.g., 0.85), and recommended priority values (1-5). The connection unit inputs these output values into a threshold judgment logic or rule-based engine and determines specific priority parameters, such as “if stress score is 0.7 or higher, priority 1,” “if relaxed, priority 5.” Furthermore, the connection unit can collaborate with a database of past emotion estimation history and connection success rates for individualized optimization (personalization). For AI model training, cross-entropy loss functions and Adam optimizers are used, and pre-training is performed on datasets of thousands to tens of thousands of facial images and audio data. In subsequent processing, if the priority is high, connection processing is executed immediately, and if low, the scheduler prioritizes other tasks. As a technical effect, the connection unit realizes real-time and highly accurate connection priority control based on emotion estimation, without relying on conventional simple timers or manual user operations, thereby reducing psychological burden on users and decreasing connection failures and stress. Application fields include priority control of safety confirmation calls in elderly monitoring systems, connection priority control according to patient psychological state in remote medical care, communication priority control according to concentration level in educational support terminals, and provision of stress-free connection experiences in support terminals for persons with disabilities. Through these configurations and processes, the connection unit goes beyond mere automation of human tasks and can technologically enhance the communication control functions of television terminals and revolutionize the user experience.

The connection unit is capable of selecting an optimal connection method by considering the user's geographic location information at the time of connection. The connection unit can, for example, acquire the user's geographic location information using GPS data or IP address. For example, if the user is at home, the connection unit prioritizes Wi-Fi connection. If the user is outside, the connection unit may prioritize mobile data connection. Furthermore, if the user is in a public place, the connection unit may select a secure connection method. Thus, by selecting the optimal connection method according to the user's geographic location information, the connection unit improves connection efficiency. Specifically, the connection unit acquires input data such as GPS module data connected to the television or IP address information obtained from the network interface. For GPS data, a structure including latitude, longitude, altitude, and timestamp (e.g., {lat:35.6, lon:139.7, alt:10.2, time:2024-06-01T10:00:00Z}) is used, and for IP address, a GeoIP database is referenced to identify regional information (country, prefecture, city level). Based on this location information, the connection unit scans candidate networks (Wi-Fi SSID list, mobile data APN list, public wireless LAN list, etc.) and extracts features such as security level (WPA2, WPA3, open, etc.), signal strength (RSSI value), bandwidth, and past connection success rate for each network. When AI processing is incorporated, the connection unit uses a classification model (e.g., random forest, LightGBM, DNN) with location information, network characteristics, and user history as input to infer the optimal connection method (Wi-Fi, mobile data, public LAN, etc.). Examples of AI input include current latitude and longitude (2D float), Wi-Fi RSSI value array (5 items), and a 24-dimensional array of connection success flags over the past 24 hours. Examples of AI output include recommended connection method label (“Wi-Fi,” “mobile data,” “public LAN”), recommended connection destination ID (SSID or APN name), and connection success probability score (0.0-1.0). These outputs are used for subsequent processing such as automatic selection by the connection control module, connection method proposals to users, and security warning displays. As a technical effect, the connection unit can greatly improve connection efficiency, security, and user experience by combining real-time location information, network characteristics, and AI prediction, compared to conventional simple network selection or manual user operations. Application fields include automatic network switching for home television terminals, secure communication path assurance for remote medical terminals, roaming support in educational settings, and automatic connection optimization for support terminals for persons with disabilities. Through these configurations, the connection unit goes beyond mere automation of human tasks and can technologically enhance the connection control functions of television terminals and revolutionize the efficiency and reliability of the entire system.

The connection unit is capable of analyzing the user's past connection history at the time of connection and proposing an optimal connection method. The connection unit can, for example, analyze history data such as connection date and time and connection success rate. For example, the connection unit may preferentially propose connection methods that the user has frequently used in the past. In addition, the connection unit may propose optimal connection timing based on the user's past connection history. Furthermore, the connection unit may analyze the user's past connection history and propose the most efficient connection method. Thus, by analyzing the user's past connection history, the connection unit can propose an optimal connection method. Specifically, the connection unit acquires a connection history database recorded in the television terminal's storage or cloud server (e.g., a structure array including connection date and time, connection method, success/failure flag, connection duration, error code, etc.) in time series. The connection unit inputs this history data into a statistical analysis module or AI model (e.g., time series clustering, LSTM-based history prediction model) to extract connection tendencies for each user (e.g., success rate by day and time, usage frequency of specific networks, failure patterns, etc.). Examples of AI input include a 720-dimensional connection history vector for the past 30 days (24 hours×30 days), success rates for each connection method (Wi-Fi: 0.95, mobile: 0.80, etc.), and an array of connection durations for the last 10 connections. Examples of AI output include recommended connection method label (“Wi-Fi,” “mobile data,” etc.), recommended connection timing (e.g., today at 19:00), connection success probability score (0.0-1.0), and recommended wait time (in seconds). These outputs are used for subsequent processing such as automatic selection by the connection control module, connection method and timing proposals to users, and connection failure risk warnings. As a technical effect, the connection unit can greatly improve connection efficiency, success rate, and user experience by combining AI-based history analysis, pattern extraction, and prediction, compared to conventional simple history reference or manual user selection. Application fields include automatic connection optimization for home television terminals, communication reliability improvement for remote medical terminals, network congestion avoidance in educational settings, and reduction of connection failures for support terminals for persons with disabilities. Through these configurations, the connection unit goes beyond mere automation of human tasks and can technologically enhance the connection control functions of television terminals and revolutionize the efficiency and reliability of the entire system.

The startup unit is capable of estimating a user's emotion and adjusting the timing of startup based on the estimated emotion. The startup unit can, for example, estimate a user's emotion using facial recognition or voice analysis. For example, the startup unit can capture the user's facial expression with a camera and estimate the emotion using an emotion estimation algorithm. In addition, the startup unit can record the user's voice with a microphone and estimate the emotion using voice analysis technology. Thus, the startup unit can adjust the timing of startup according to the user's emotion. Emotion estimation is realized, for example, by using an emotion engine or generative AI for emotion estimation functions. Generative AI may include text generation AI (e.g., LLM) or multimodal generative AI, but is not limited to these examples. For example, if the user is relaxed, the startup unit may delay the timing of startup to provide the user with time to prepare. If the user is in a hurry, the startup unit may expedite the timing of startup for rapid startup. Furthermore, if the user feels anxious, the startup unit may adjust the timing of startup to ensure the user feels secure. Thus, by adjusting the timing of startup according to the user's emotion, the startup unit enables more appropriate startup. Specifically, the startup unit acquires facial images (e.g., 112×112×3 RGB tensor) obtained from a camera device connected to the television and audio waveform data (e.g., 16 kHz, 16 bit PCM format, 16,000 samples per second float array) obtained from a microphone device as input data. The startup unit extracts facial features and audio features (e.g., MFCC, spectrogram) from these input data using convolutional neural networks (CNN) and time series analysis models (e.g., LSTM, Transformer-based voice emotion recognition models). The startup unit inputs the extracted features into a multilayer perceptron or multimodal fusion network and outputs emotion labels (e.g., “relaxed,” “in a hurry,” “anxious”) and emotion scores (continuous values from 0.0 to 1.0). Examples of AI input include face image tensors (112×112×3), audio spectrograms (128×128 float array), and multimodal feature vectors (concatenated face and voice vectors). Examples of AI output include emotion labels (“relaxed,” “in a hurry,” “anxious”), emotion scores (e.g., 0.85), and recommended startup timing (delay value in seconds). The startup unit inputs these output values into a threshold judgment logic or rule-based engine and determines specific timing adjustment parameters, such as “if relaxed, delay by 30 seconds,” “if in a hurry, start immediately.” Furthermore, the startup unit can collaborate with a database of past emotion estimation history and startup success rates for individualized optimization (personalization). For AI model training, cross-entropy loss functions and Adam optimizers are used, and pre-training is performed on datasets of thousands to tens of thousands of facial images and audio data. In subsequent processing, startup processing is submitted to the scheduler according to the recommended timing, and notifications for startup preparation or reassurance messages are displayed to the user. As a technical effect, the startup unit realizes real-time and highly accurate startup timing control based on emotion estimation, without relying on conventional simple timers or manual user operations, thereby reducing psychological burden on users and decreasing startup failures and stress. Application fields include secure startup control in elderly monitoring systems, startup timing control according to patient psychological state in remote medical care, startup control according to concentration level in educational support terminals, and provision of stress-free startup experiences in support terminals for persons with disabilities. Through these configurations and processes, the startup unit goes beyond mere automation of human tasks and can technologically enhance the startup control functions of television terminals and revolutionize the user experience.

The startup unit is capable of detecting the usage status of the television at the time of startup and selecting an optimal startup timing. The startup unit can, for example, detect the power on/off status of the television and the current input source. For example, if the television is using another application, the startup unit may delay startup and wait for the application to finish. If the television is powered off, the startup unit may wait until the power is turned on before starting. Furthermore, if the television is recording, the startup unit may delay startup until the recording is finished. Thus, by selecting the optimal startup timing according to the usage status of the television, the startup unit improves startup efficiency. Specifically, the startup unit acquires status information such as power state (ON/OFF), input source type (HDMI, USB, AV, etc.), currently running application ID, and recording process status (recording/not recording) every second via the television's system API, either by polling or event-driven methods. The startup unit manages the acquired status information as bit flags or structures (e.g., power: 1, input: HDMI, app: recording, rec: 1) and uses a state transition detection algorithm (e.g., state transition graph, priority queue) to determine startup conditions (e.g., power ON, not recording, no application in use). If the conditions are not met, the startup unit re-evaluates at regular intervals and executes application startup processing only when the conditions are satisfied. Furthermore, the startup unit can hook recording end events or application termination events to immediately resume startup processing. When AI processing is incorporated, the startup unit can learn past television usage history (e.g., recording frequency by day and time, application usage patterns) as time series data and use a time series prediction model (e.g., LSTM, Transformer) to predict optimal startup timing. Examples of AI input include a binary vector of recording/application usage flags for each hour over the past 7 days (168 dimensions), and a current system state vector (4 dimensions). Examples of AI output include recommended startup timing (e.g., after 19:00 today), startup success probability score (0.0-1.0), and startup wait recommendation flag (1/0). These outputs are used for subsequent processing such as automatic control of the startup scheduler, startup wait notifications to users, and reduction of startup failure risk. As a technical effect, the startup unit can optimize startup timing, reduce startup failure rates, and improve user experience by combining real-time television usage status, history analysis, and AI prediction, compared to conventional simple timers or manual user operations. Application fields include application startup control for home television terminals, automatic startup for remote medical terminals, optimization of teaching material distribution timing in educational settings, and automatic startup control for support terminals for persons with disabilities. Through these configurations, the startup unit goes beyond mere automation of human tasks and can technologically enhance the startup control functions of television terminals and revolutionize the efficiency and reliability of the entire system.

The startup unit is capable of performing filtering to avoid interference with other applications of the television at the time of startup. The startup unit can, for example, monitor memory usage and CPU load to perform filtering to avoid interference with other applications. For example, if other applications are running in the background, the startup unit may adjust startup to avoid interference with those applications. In addition, the startup unit can monitor the television's system resources and delay startup if resources are insufficient. Furthermore, the startup unit can monitor the television's network connection status and delay startup if the connection is unstable. Thus, by avoiding interference with other applications, the startup unit improves startup stability. Specifically, the startup unit acquires system resource information such as memory usage (in MB), CPU load (%), GPU usage rate, network bandwidth usage (Mbps), and number of background processes every second using the television's resource monitoring API. The startup unit manages this information as a resource management table (e.g., a structure storing thresholds, current values, and priorities for each resource) and executes interference determination algorithms (e.g., resource overuse detection, process competition determination, bandwidth competition determination). For example, if memory usage exceeds 80%, startup is delayed; if CPU load is 90% or higher, startup waits for background processes to terminate; if network bandwidth is less than 2 Mbps, startup is held until network stabilization. When AI processing is incorporated, the startup unit can learn from past resource competition history (e.g., resource status at startup failure, error codes) as training data and use a classification model (e.g., random forest, LightGBM, DNN) to predict the probability of interference occurrence. Examples of AI input include current resource state vectors (usage rates for memory, CPU, GPU, network), and a 24-dimensional array of interference occurrence flags over the past 24 hours. Examples of AI output include interference risk score (0.0-1.0), recommended startup timing (e.g., 5 seconds later), and priority startup application ID (e.g., messenger application). These outputs are used for subsequent processing such as automatic control of the startup scheduler, startup order proposals to users, and automatic restart processing to avoid interference. As a technical effect, the startup unit can greatly improve startup stability, system reliability, and user experience by combining real-time resource status monitoring, AI-based interference prediction, and automatic filtering, compared to conventional simple application startup control. Application fields include multi-application startup control for home television terminals, stable operation assurance for remote medical terminals, simultaneous use of multiple teaching materials in educational settings, and reliability improvement for support terminals for persons with disabilities. Through these configurations, the startup unit goes beyond mere automation of human tasks and can technologically enhance the application startup management functions of television terminals and revolutionize the stability and reliability of the entire system.

The startup unit is capable of estimating a user's emotion and determining the priority of startup based on the estimated emotion. The startup unit can, for example, estimate a user's emotion using facial recognition or voice analysis. For example, the startup unit can capture the user's facial expression with a camera and estimate the emotion using an emotion estimation algorithm. In addition, the startup unit can record the user's voice with a microphone and estimate the emotion using voice analysis technology. Thus, the startup unit can determine the priority of startup according to the user's emotion. Emotion estimation is realized, for example, by using an emotion engine or generative AI for emotion estimation functions. Generative AI may include text generation AI (e.g., LLM) or multimodal generative AI, but is not limited to these examples. For example, if the user feels stressed, the startup unit sets a high priority for startup and starts quickly. If the user is relaxed, the startup unit sets a low priority and may prioritize other tasks. Furthermore, if the user is in a hurry, the startup unit sets a high priority and starts quickly. Thus, by determining the priority of startup according to the user's emotion, the startup unit enables more appropriate startup. Specifically, the startup unit acquires facial images (112×112×3 RGB tensor) obtained from a camera device connected to the television and audio waveform data (16kHz, 16 bit PCM format, 16,000 samples per second float array) obtained from a microphone device as input data. The startup unit extracts facial features and audio features (MFCC, spectrogram) from these input data using convolutional neural networks (CNN) and time series analysis models (LSTM, Transformer-based voice emotion recognition models). The startup unit inputs the extracted features into a multilayer perceptron or multimodal fusion network and outputs emotion labels (“stress,” “relaxed,” “in a hurry”), emotion scores (continuous values from 0.0 to 1.0), and recommended priority values (1 to 5 levels). Examples of AI input include face image tensors (112×112×3), audio spectrograms (128×128 float array), and multimodal feature vectors (concatenated face and voice vectors). Examples of AI output include emotion labels (“stress,” “relaxed,” “in a hurry”), emotion scores (e.g., 0.85), and recommended priority values (1-5). The startup unit inputs these output values into a threshold judgment logic or rule-based engine and determines specific priority parameters, such as “if stress score is 0.7 or higher, priority 1,” “if relaxed, priority 5.” Furthermore, the startup unit can collaborate with a database of past emotion estimation history and startup success rates for individualized optimization (personalization). For AI model training, cross-entropy loss functions and Adam optimizers are used, and pre-training is performed on datasets of thousands to tens of thousands of facial images and audio data. In subsequent processing, if the priority is high, startup processing is executed immediately, and if low, the scheduler prioritizes other tasks. As a technical effect, the startup unit realizes real-time and highly accurate startup priority control based on emotion estimation, without relying on conventional simple timers or manual user operations, thereby reducing psychological burden on users and decreasing startup failures and stress. Application fields include secure startup control in elderly monitoring systems, startup priority control according to patient psychological state in remote medical care, startup priority control according to concentration level in educational support terminals, and provision of stress-free startup experiences in support terminals for persons with disabilities. Through these configurations and processes, the startup unit goes beyond mere automation of human tasks and can technologically enhance the startup control functions of television terminals and revolutionize the user experience.

The startup unit is capable of selecting an optimal startup method by considering the user's geographic location information at the time of startup. The startup unit can, for example, acquire the user's geographic location information using GPS data or IP address. For example, if the user is at home, the startup unit prioritizes Wi-Fi connection for startup. If the user is outside, the startup unit may prioritize mobile data connection for startup. Furthermore, if the user is in a public place, the startup unit may select a secure connection method for startup. Thus, by selecting the optimal startup method according to the user's geographic location information, the startup unit improves startup efficiency. Specifically, the startup unit acquires input data such as GPS module data connected to the television or IP address information obtained from the network interface. For GPS data, a structure including latitude, longitude, altitude, and timestamp (e.g., lat:35.6, lon:139.7, alt:10.2, time:2024-06-01T10:00:00Z) is used, and for IP address, a GeoIP database is referenced to identify regional information (country, prefecture, city level). Based on this location information, the startup unit scans candidate networks (Wi-Fi SSID list, mobile data APN list, public wireless LAN list, etc.) and extracts features such as security level (WPA2, WPA3, open, etc.), signal strength (RSSI value), bandwidth, and past connection success rate for each network. When AI processing is incorporated, the startup unit uses a classification model (e.g., random forest, LightGBM, DNN) with location information, network characteristics, and user history as input to infer the optimal startup method (Wi-Fi, mobile data, public LAN, etc.). Examples of AI input include current latitude and longitude (2D float), Wi-Fi RSSI value array (5 items), and a 24-dimensional array of connection success flags over the past 24 hours. Examples of AI output include recommended startup method label (Wi-Fi, mobile data, public LAN), recommended startup destination ID (SSID or APN name), and startup success probability score (0.0-1.0). These outputs are used for subsequent processing such as automatic selection by the startup control module, startup method proposals to users, and security warning displays. As a technical effect, the startup unit can greatly improve startup efficiency, security, and user experience by combining real-time location information, network characteristics, and AI prediction, compared to conventional simple network selection or manual user operations. Application fields include automatic network switching startup for home television terminals, secure communication path assurance for remote medical terminals, roaming support startup in educational settings, and automatic startup optimization for support terminals for persons with disabilities. Through these configurations, the startup unit goes beyond mere automation of human tasks and can technologically enhance the startup control functions of television terminals and revolutionize the efficiency and reliability of the entire system.

The startup unit can analyze the user's past startup history at the time of startup and propose an optimal startup method. The startup unit can, for example, analyze historical data such as startup date and time or startup success rate. For instance, the startup unit preferentially proposes startup methods that the user has frequently used in the past. Additionally, the startup unit can propose an optimal startup timing based on the user's past startup history. Furthermore, the startup unit can analyze the user's past startup history and propose the most efficient startup method. Thus, by analyzing the user's past startup history, the startup unit can propose an optimal startup method. Specifically, the startup unit acquires a startup history database recorded in the television terminal's storage or a cloud server (e.g., a structured array including startup date and time, startup method, success/failure flag, required startup time, error code, etc.) in chronological order. The startup unit inputs these historical data into a statistical analysis module or AI model (e.g., time-series clustering, LSTM-based history prediction model) to extract user-specific startup tendencies (e.g., success rate by day of week and time, frequency of specific network usage, failure patterns, etc.). Examples of AI input include a startup history vector for the past 30 days (720 dimensions: 24 hours×30 days), success rates for each startup method (Wi-Fi: 0.95, mobile: 0.80, etc.), and an array of required startup times for the most recent 10 startups. Examples of AI output include recommended startup method labels (Wi-Fi, mobile data, etc.), recommended startup timing (e.g., today at 19:00), startup success probability score (0.0-1.0), and recommended waiting time (in seconds). These outputs are used for subsequent processing such as automatic selection by the startup control module, proposals of startup method and timing to the user, and startup failure risk warnings. As a technical effect, the startup unit can greatly improve startup efficiency, success rate, and user experience by combining AI-based history analysis, pattern extraction, and prediction, compared to conventional simple history reference or manual user selection. Application fields include automatic startup optimization for home television terminals, reliability improvement for remote medical terminals, network congestion avoidance startup in educational settings, and reduction of startup failures for assistive terminals for disabled persons. With these configurations, the startup unit goes beyond mere automation of human tasks, technically advances the startup control function of television terminals, and can revolutionize the efficiency and reliability of the entire system.

The operation unit can estimate the user's emotion and adjust the operation interface based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the operation interface according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is nervous, the operation unit provides an interface with calm colors to reduce visual stress. If the user is enjoying themselves, the operation unit provides an interface with bright colors to make the operation more enjoyable. Furthermore, if the user is tired, the operation unit provides a simple and highly visible interface to facilitate operation. Thus, by adjusting the operation interface according to the user's emotion, the operation unit enables more appropriate operation. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit extracts facial features and voice features (MFCC, spectrogram, etc.) from these input data using convolutional neural networks (CNN) and time-series analysis models (LSTM, Transformer-based voice emotion recognition models). The extracted features are input into a multilayer perceptron or multimodal fusion network to output emotion labels (e.g., “nervous,” “enjoyment,” “fatigue,” etc.) and emotion scores (continuous values from 0.0 to 1.0). Examples of AI input include facial image tensors (112×112×3), voice spectrograms (128×128 float array), and multimodal feature vectors (concatenated face and voice vectors). Examples of AI output include emotion labels (“nervous,” “enjoyment,” “fatigue”), emotion scores (e.g., 0.85), and recommended UI settings (“calm color scheme,” “bright color scheme,” “simple UI,” etc.). The operation unit inputs these output values into threshold judgment logic or rule-based engines to determine specific UI adjustment parameters, such as “if nervous score is 0.7 or higher, use calm colors,” “if enjoyment, use bright colors,” “if fatigue, use simple UI,” etc. Furthermore, the operation unit can collaborate with the user's past emotion estimation history and UI usage history database to perform individual optimization (personalization). For AI model training, cross-entropy loss functions and Adam optimizers are used, and pre-training is performed on datasets of thousands to tens of thousands of facial images and voice data. In subsequent processing, UI drawing engine parameters are set according to recommended UI settings, and UI color, layout, font size, etc. are automatically adjusted in real time. As a technical effect, the operation unit can reduce psychological burden and decrease operation errors and stress by realizing automatic interface adjustment based on real-time, high-precision emotion estimation, without relying on conventional fixed UI display or manual user settings. Application fields include accessibility optimization for elderly or disabled persons, UI adjustment according to patient psychological state in remote medical terminals, UI optimization according to children's concentration in educational support terminals, and emotion-linked UI provision in family communication terminals. With these configurations and processes, the operation unit goes beyond mere automation of human tasks, technically advances the operation interface function of television terminals, and can revolutionize the user experience.

The operation unit can refer to the user's past operation history at the time of operation and propose an optimal operation method. The operation unit can, for example, refer to historical data such as operation date and time or operation success rate. For instance, the operation unit preferentially proposes operation methods that the user has frequently used in the past. Additionally, the operation unit can propose an optimal operation timing based on the user's past operation history. Furthermore, the operation unit can analyze the user's past operation history and propose the most efficient operation method. Thus, by referring to the user's past operation history, the operation unit can propose an optimal operation method. Specifically, the operation unit acquires an operation history database recorded in the television terminal's storage or a cloud server (e.g., a structured array including operation date and time, operation type, success/failure flag, required operation time, error code, etc.) in chronological order. The operation unit inputs these historical data into a statistical analysis module or AI model (e.g., time-series clustering, LSTM-based history prediction model) to extract user-specific operation tendencies (e.g., success rate by day of week and time, frequency of specific operations, failure patterns, etc.). Examples of AI input include an operation history vector for the past 30 days (720 dimensions: 24 hours×30 days), success rates for each operation type (message sending: 0.95, photo sharing: 0.80, etc.), and an array of required operation times for the most recent 10 operations. Examples of AI output include recommended operation method labels (“remote control operation,” “voice input,” etc.), recommended operation timing (e.g., today at 19:00), operation success probability score (0.0-1.0), and recommended waiting time (in seconds). These outputs are used for subsequent processing such as automatic selection by the operation control module, proposals of operation method and timing to the user, and operation failure risk warnings. As a technical effect, the operation unit can greatly improve operation efficiency, success rate, and user experience by combining AI-based history analysis, pattern extraction, and prediction, compared to conventional simple history reference or manual user selection. Application fields include automatic operation optimization for home television terminals, reliability improvement for remote medical terminals, operation congestion avoidance in educational settings, and reduction of operation failures for assistive terminals for disabled persons. With these configurations, the operation unit goes beyond mere automation of human tasks, technically advances the operation control function of television terminals, and can revolutionize the efficiency and reliability of the entire system.

The operation unit can customize the operation procedure based on the user's current usage status at the time of operation. The operation unit can, for example, detect active applications or device status. For instance, if the user is using another application, the operation unit adjusts the operation procedure to avoid interference with that application. Additionally, if the user is watching television, the operation unit adjusts the operation procedure so as not to interrupt viewing. Furthermore, if the user is using a remote controller, the operation unit customizes the operation procedure according to the button layout of the remote controller. Thus, by customizing the operation procedure according to the user's current usage status, the operation unit improves operation efficiency. Specifically, the operation unit acquires, every second, the currently active application ID, device status (power ON/OFF, recording/not recording, network connection status, etc.), remote controller type, and button layout information via the television system API. The operation unit manages these various status information as bit flags or structures and uses a state transition detection algorithm (e.g., state transition graph, priority queue) to determine operation conditions and optimal procedure branches. When incorporating AI processing, the operation unit can use a time-series prediction model (LSTM, Transformer, etc.) that learns past usage history (e.g., application usage patterns, device state transitions, remote control operation history) as time-series data to predict optimal operation procedures. Examples of AI input include a binary vector of application usage flags for each hour over the past 7 days (168 dimensions), current system state vector (4 dimensions), and remote controller button layout vector (16 dimensions). Examples of AI output include recommended operation procedure labels (“notify without interruption,” “background execution,” etc.), recommended operation timing (e.g., after recording ends), and operation success probability score (0.0-1.0). These outputs are used for subsequent processing such as automatic branching by the operation procedure control module, proposals of operation procedure and timing to the user, and operation failure risk warnings. As a technical effect, the operation unit can greatly improve operation efficiency, success rate, and user experience by combining real-time usage status monitoring, AI prediction, and automatic customization, compared to conventional fixed operation procedures or manual user branching. Application fields include multi-application operation control for home television terminals, operation optimization for remote medical terminals, simultaneous use of multiple teaching materials in educational settings, and reliability improvement for assistive terminals for disabled persons. With these configurations, the operation unit goes beyond mere automation of human tasks, technically advances the operation procedure management function of television terminals, and can revolutionize the efficiency and reliability of the entire system.

The operation unit can estimate the user's emotion and determine the priority of operation based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can determine the priority of operation according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is feeling stressed, the operation unit sets a high priority for operation and performs the operation quickly. If the user is relaxed, the operation unit sets a low priority for operation and may prioritize other tasks. Furthermore, if the user is in a hurry, the operation unit sets a high priority for operation and performs the operation quickly. Thus, by determining the priority of operation according to the user's emotion, the operation unit enables more appropriate operation. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit extracts facial features and voice features (MFCC, spectrogram) from these input data using convolutional neural networks (CNN) and time-series analysis models (LSTM, Transformer-based voice emotion recognition models). The extracted features are input into a multilayer perceptron or multimodal fusion network to output emotion labels (“stress,” “relaxation,” “hurry,” etc.), emotion scores (continuous values from 0.0 to 1.0), and recommended priority values (1 to 5 levels). Examples of AI input include facial image tensors (112×112×3), voice spectrograms (128×128 float array), and multimodal feature vectors (concatenated face and voice vectors). Examples of AI output include emotion labels (“stress,” “relaxation,” “hurry”), emotion scores (e.g., 0.85), and recommended priority values (1-5). The operation unit inputs these output values into threshold judgment logic or rule-based engines to determine specific priority parameters, such as “if stress score is 0.7 or higher, priority 1,” “if relaxation, priority 5,” etc. Furthermore, the operation unit can collaborate with the user's past emotion estimation history and operation success rate database to perform individual optimization (personalization). For AI model training, cross-entropy loss functions and Adam optimizers are used, and pre-training is performed on datasets of thousands to tens of thousands of facial images and voice data. In subsequent processing, if the priority is high, the operation is executed immediately; if low, the scheduler prioritizes other tasks. As a technical effect, the operation unit can reduce psychological burden and decrease operation failures and stress by realizing priority control of operation based on real-time, high-precision emotion estimation, without relying on conventional simple timers or manual user operation. Application fields include safe operation control in elderly monitoring systems, priority control according to patient psychological state in remote medical care, priority control according to children's concentration in educational support terminals, and stress-free operation experience in assistive terminals for disabled persons. With these configurations and processes, the operation unit goes beyond mere automation of human tasks, technically advances the operation control function of television terminals, and can revolutionize the user experience.

The operation unit can select an optimal operation method by considering the user's geographic location information at the time of operation. The operation unit can, for example, acquire the user's geographic location information using GPS data or IP address. For instance, if the user is at home, the operation unit prioritizes Wi-Fi connection for operation. If the user is outside, the operation unit prioritizes mobile data connection for operation. Furthermore, if the user is in a public place, the operation unit selects a secure connection method for operation. Thus, by selecting an optimal operation method according to the user's geographic location information, the operation unit improves operation efficiency. Specifically, the operation unit acquires GPS module data connected to the television or IP address information obtained from the network interface as input data. For GPS data, a structure including latitude, longitude, altitude, and timestamp (e.g., lat: 35.6, lon: 139.7, alt: 10.2, time: 2024-06-01T10:00:00Z) is used; for IP address, the GeoIP database is referenced to identify regional information (country, prefecture, city level). The operation unit scans operation candidate networks (Wi-Fi SSID list, mobile data APN list, public wireless LAN list, etc.) based on this location information and extracts features such as security level (WPA2, WPA3, open, etc.), signal strength (RSSI value), bandwidth, and past connection success rate for each network. When incorporating AI processing, the operation unit uses a classification model (random forest, LightGBM, DNN, etc.) with location information, network characteristics, and user history as input to infer the optimal operation method (Wi-Fi, mobile data, public LAN, etc.). Examples of AI input include current location latitude and longitude (2-dimensional float), Wi-Fi RSSI value array (5 items), and connection success flag array for the past 24 hours (24 dimensions). Examples of AI output include recommended operation method labels (“Wi-Fi,” “mobile data,” “public LAN”), recommended operation destination ID (SSID or APN name), and operation success probability score (0.0-1.0). These outputs are used for subsequent processing such as automatic selection by the operation control module, proposals of operation method to the user, and security warning display. As a technical effect, the operation unit can greatly improve operation efficiency, security, and user experience by combining real-time location information, network characteristics, and AI prediction, compared to conventional simple network selection or manual user operation. Application fields include automatic network switching operation for home television terminals, secure communication channel assurance for remote medical terminals, roaming support operation in educational settings, and automatic operation optimization for assistive terminals for disabled persons. With these configurations, the operation unit goes beyond mere automation of human tasks, technically advances the operation control function of television terminals, and can revolutionize the efficiency and reliability of the entire system.

The operation unit can analyze the user's social media activity at the time of operation and propose a relevant operation method. The operation unit can, for example, analyze social media activity data such as post content or number of likes. For instance, the operation unit preferentially proposes operation methods for social media applications that the user frequently uses. Additionally, the operation unit can propose an optimal operation timing based on the user's social media activity. Furthermore, the operation unit can analyze the user's social media activity and propose the most efficient operation method. Thus, by analyzing the user's social media activity, the operation unit can propose relevant operation methods. Specifically, the operation unit collects social media activity data (e.g., post text, presence of attached images, post time, number of likes, number of comments, number of shares, application ID used, etc.) obtained from the television terminal or linked mobile terminal in JSON format or as a structured array. The operation unit inputs these data into a natural language processing engine (e.g., BERT-based text classification model) or time-series analysis model (e.g., LSTM, Transformer, etc.) to extract features such as post content category (e.g., daily life, events, health, hobbies, etc.), activity frequency, and response tendencies (e.g., patterns of increase or decrease in number of likes). Examples of AI input include post text sequences for the past 30 days (100 tokens per post×30 posts), numerical vectors for number of likes, comments, and shares for each post (30×3 dimensions), and one-hot vectors for application IDs used (10 dimensions). Examples of AI output include recommended operation method labels (“image posting priority,” “comment reply priority,” “story posting recommendation,” etc.), recommended operation timing (e.g., today at 20:00), operation success probability score (0.0-1.0), and recommended application ID (e.g., app 3). The operation unit inputs these output values into the operation control module and, in combination with the user's current usage status and past operation history, proposes optimal operation methods, timing, and application choices to the user in real time. Furthermore, the operation unit can collaborate with emotion estimation (e.g., emotion analysis from post content, emotion estimation from facial images or voice) to provide personalized proposals, such as recommending active posting operations when the user is in a positive emotional state, or browsing-focused operations when in a negative state. For AI model training, cross-entropy loss functions and Adam optimizers are used, and pre-training is performed on datasets of tens of thousands of social media activity records. In subsequent processing, the UI is automatically switched according to the recommended operation method, notifications and one-touch operation buttons are displayed to the user, and operation history is automatically recorded. As a technical effect, the operation unit can greatly improve operation efficiency, success rate, and user experience by combining AI-based social media activity analysis, pattern extraction, and real-time proposals, compared to conventional simple history reference or manual user selection. Application fields include SNS-linked operation optimization for home television terminals, patient SNS activity monitoring in remote medical terminals, learning SNS support in educational settings, and SNS operation assistance for assistive terminals for disabled persons. With these configurations, the operation unit goes beyond mere automation of human tasks, technically advances the operation control function of television terminals, and can revolutionize the efficiency and reliability of the entire system.

The operation unit can estimate the user's emotion and adjust the timing of message transmission based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the timing of message transmission according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is relaxed, the operation unit delays the timing of message transmission to provide the user with time to prepare. If the user is in a hurry, the operation unit advances the timing of message transmission for rapid transmission. Furthermore, if the user is feeling anxious, the operation unit adjusts the timing of message transmission to help the user feel at ease. Thus, by adjusting the timing of message transmission according to the user's emotion, the operation unit enables more appropriate message transmission. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit inputs these data into convolutional neural networks (CNN) and time-series analysis models (LSTM, Transformer-based voice emotion recognition models) to extract facial features and voice features (MFCC, spectrogram, etc.). The extracted features are input into a multilayer perceptron or multimodal fusion network to output emotion labels (“relaxation,” “hurry,” “anxiety,” etc.), emotion scores (continuous values from 0.0 to 1.0), and recommended transmission timing (delay value in seconds). Examples of AI input include facial image tensors (112×112×3), voice spectrograms (128×128 float array), and multimodal feature vectors (concatenated face and voice vectors). Examples of AI output include emotion labels (“relaxation,” “hurry,” “anxiety”), emotion scores (e.g., 0.85), and recommended transmission timing (e.g., 5 seconds delay, immediate transmission). The operation unit inputs these output values into threshold judgment logic or rule-based engines to determine specific timing adjustment parameters, such as “if relaxation, 10 seconds delay,” “if hurry, immediate transmission,” etc. Furthermore, the operation unit can collaborate with the user's past emotion estimation history and transmission success rate database to perform individual optimization (personalization). For AI model training, cross-entropy loss functions and Adam optimizers are used, and pre-training is performed on datasets of thousands to tens of thousands of facial images and voice data. In subsequent processing, transmission processing is submitted to the scheduler according to the recommended timing, and transmission preparation notifications or reassurance messages are displayed to the user. As a technical effect, the operation unit can reduce psychological burden and decrease transmission failures and stress by realizing transmission timing control based on real-time, high-precision emotion estimation, without relying on conventional simple timers or manual user operation. Application fields include reassurance transmission control in elderly monitoring systems, transmission timing control according to patient psychological state in remote medical care, transmission control according to children's concentration in educational support terminals, and stress-free transmission experience in assistive terminals for disabled persons. With these configurations and processes, the operation unit goes beyond mere automation of human tasks, technically advances the message transmission control function of television terminals, and can revolutionize the user experience.

The operation unit can refer to the user's past message history at the time of sending and receiving messages and propose an optimal transmission method. The operation unit can, for example, refer to historical data such as message content or transmission date and time. For instance, the operation unit preferentially proposes transmission methods that the user has frequently used in the past. Additionally, the operation unit can propose an optimal transmission timing based on the user's past message history. Furthermore, the operation unit can analyze the user's past message history and propose the most efficient transmission method. Thus, by referring to the user's past message history, the operation unit can propose an optimal transmission method. Specifically, the operation unit acquires a message history database recorded in the television terminal's storage or a cloud server (e.g., a structured array including transmission date and time, reception date and time, message type, transmission method, success/failure flag, required time, error code, etc.) in chronological order. The operation unit inputs these historical data into a statistical analysis module or AI model (e.g., time-series clustering, LSTM-based history prediction model) to extract user-specific transmission tendencies (e.g., success rate by day of week and time, frequency of specific transmission methods, failure patterns, etc.). Examples of AI input include a message history vector for the past 30 days (720 dimensions: 24 hours×30 days), success rates for each transmission method (text: 0.95, voice: 0.80, etc.), and an array of required transmission times for the most recent 10 transmissions. Examples of AI output include recommended transmission method labels (“text,” “voice,” “image,” etc.), recommended transmission timing (e.g., today at 19:00), transmission success probability score (0.0-1.0), and recommended waiting time (in seconds). These outputs are used for subsequent processing such as automatic selection by the transmission control module, proposals of transmission method and timing to the user, and transmission failure risk warnings. As a technical effect, the operation unit can greatly improve transmission efficiency, success rate, and user experience by combining AI-based history analysis, pattern extraction, and prediction, compared to conventional simple history reference or manual user selection. Application fields include automatic transmission optimization for home television terminals, reliability improvement for remote medical terminals, transmission congestion avoidance in educational settings, and reduction of transmission failures for assistive terminals for disabled persons. With these configurations, the operation unit goes beyond mere automation of human tasks, technically advances the transmission control function of television terminals, and can revolutionize the efficiency and reliability of the entire system.

The operation unit can estimate the user's emotion and adjust the timing of sharing photos or videos based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the timing of sharing photos or videos according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is relaxed, the operation unit delays the timing of sharing photos or videos to provide the user with time to prepare. If the user is in a hurry, the operation unit advances the timing of sharing for rapid sharing. Furthermore, if the user is feeling anxious, the operation unit adjusts the timing of sharing to help the user feel at ease. Thus, by adjusting the timing of sharing photos or videos according to the user's emotion, the operation unit enables more appropriate sharing. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit inputs these data into convolutional neural networks (CNN) and time-series analysis models (LSTM, Transformer-based voice emotion recognition models) to extract facial features and voice features (MFCC, spectrogram, etc.). The extracted features are input into a multilayer perceptron or multimodal fusion network to output emotion labels (“relaxation,” “hurry,” “anxiety,” etc.), emotion scores (continuous values from 0.0 to 1.0), and recommended sharing timing (delay value in seconds). Examples of AI input include facial image tensors (112×112×3), voice spectrograms (128×128 float array), and multimodal feature vectors (concatenated face and voice vectors). Examples of AI output include emotion labels (“relaxation,” “hurry,” “anxiety”), emotion scores (e.g., 0.85), and recommended sharing timing (e.g., 5 seconds delay, immediate sharing). The operation unit inputs these output values into threshold judgment logic or rule-based engines to determine specific timing adjustment parameters, such as “if relaxation, 10 seconds delay,” “if hurry, immediate sharing,” etc. Furthermore, the operation unit can collaborate with the user's past emotion estimation history and sharing success rate database to perform individual optimization (personalization). For AI model training, cross-entropy loss functions and Adam optimizers are used, and pre-training is performed on datasets of thousands to tens of thousands of facial images and voice data. In subsequent processing, sharing processing is submitted to the scheduler according to the recommended timing, and sharing preparation notifications or reassurance messages are displayed to the user. As a technical effect, the operation unit can reduce psychological burden and decrease sharing failures and stress by realizing sharing timing control based on real-time, high-precision emotion estimation, without relying on conventional simple timers or manual user operation. Application fields include reassurance sharing control in elderly monitoring systems, sharing timing control according to patient psychological state in remote medical care, sharing control according to children's concentration in educational support terminals, and stress-free sharing experience in assistive terminals for disabled persons. With these configurations and processes, the operation unit goes beyond mere automation of human tasks, technically advances the sharing control function of television terminals, and can revolutionize the user experience.

The operation unit can refer to the user's past sharing history at the time of sharing photos or videos and propose an optimal sharing method. The operation unit can, for example, refer to historical data such as sharing date and time or sharing content. For instance, the operation unit preferentially proposes sharing methods that the user has frequently used in the past. Additionally, the operation unit can propose an optimal sharing timing based on the user's past sharing history. Furthermore, the operation unit can analyze the user's past sharing history and propose the most efficient sharing method. Thus, by referring to the user's past sharing history, the operation unit can propose an optimal sharing method. Specifically, the operation unit acquires a sharing history database recorded in the television terminal's storage or a cloud server (e.g., a structured array including sharing date and time, sharing content type, sharing method, success/failure flag, required time, error code, etc.) in chronological order. The operation unit inputs these historical data into a statistical analysis module or AI model (e.g., time-series clustering, LSTM-based history prediction model) to extract user-specific sharing tendencies (e.g., success rate by day of week and time, frequency of specific sharing methods, failure patterns, etc.). Examples of AI input include a sharing history vector for the past 30 days (720 dimensions: 24 hours×30 days), success rates for each sharing method (image: 0.95, video: 0.80, etc.), and an array of required sharing times for the most recent 10 sharings. Examples of AI output include recommended sharing method labels (“image,” “video,” “album,” etc.), recommended sharing timing (e.g., today at 19:00), sharing success probability score (0.0-1.0), and recommended waiting time (in seconds). These outputs are used for subsequent processing such as automatic selection by the sharing control module, proposals of sharing method and timing to the user, and sharing failure risk warnings. As a technical effect, the operation unit can greatly improve sharing efficiency, success rate, and user experience by combining AI-based history analysis, pattern extraction, and prediction, compared to conventional simple history reference or manual user selection. Application fields include automatic sharing optimization for home television terminals, reliability improvement for remote medical terminals, sharing congestion avoidance in educational settings, and reduction of sharing failures for assistive terminals for disabled persons. With these configurations, the operation unit goes beyond mere automation of human tasks, technically advances the sharing control function of television terminals, and can revolutionize the efficiency and reliability of the entire system.

The operation unit can estimate the user's emotion and adjust the timing of starting a video call based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the timing of starting a video call according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is relaxed, the operation unit delays the timing of starting a video call to provide the user with time to prepare. If the user is in a hurry, the operation unit advances the timing of starting the call for rapid connection. Furthermore, if the user is feeling anxious, the operation unit adjusts the timing of starting the call to help the user feel at ease. Thus, by adjusting the timing of starting a video call according to the user's emotion, the operation unit enables more appropriate video calls. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit inputs these data into convolutional neural networks (CNN) and time-series analysis models (LSTM, Transformer-based voice emotion recognition models) to extract facial features and voice features (MFCC, spectrogram, etc.). The extracted features are input into a multilayer perceptron or multimodal fusion network to output emotion labels (“relaxation,” “hurry,” “anxiety,” etc.), emotion scores (continuous values from 0.0 to 1.0), and recommended call start timing (delay value in seconds). Examples of AI input include facial image tensors (112×112×3), voice spectrograms (128×128 float array), and multimodal feature vectors (concatenated face and voice vectors). Examples of AI output include emotion labels (“relaxation,” “hurry,” “anxiety”), emotion scores (e.g., 0.85), and recommended call start timing (e.g., 5 seconds delay, immediate start). The operation unit inputs these output values into threshold judgment logic or rule-based engines to determine specific timing adjustment parameters, such as “if relaxation, 10 seconds delay,” “if hurry, immediate start,” etc. Furthermore, the operation unit can collaborate with the user's past emotion estimation history and call success rate database to perform individual optimization (personalization). For AI model training, cross-entropy loss functions and Adam optimizers are used, and pre-training is performed on datasets of thousands to tens of thousands of facial images and voice data. In subsequent processing, call start processing is submitted to the scheduler according to the recommended timing, and call preparation notifications or reassurance messages are displayed to the user. As a technical effect, the operation unit can reduce psychological burden and decrease call failures and stress by realizing call start timing control based on real-time, high-precision emotion estimation, without relying on conventional simple timers or manual user operation. Application fields include reassurance call control in elderly monitoring systems, call timing control according to patient psychological state in remote medical care, call control according to children's concentration in educational support terminals, and stress-free call experience in assistive terminals for disabled persons. With these configurations and processes, the operation unit goes beyond mere automation of human tasks, technically advances the call control function of television terminals, and can revolutionize the user experience.

The operation unit can refer to the user's past call history at the time of video calls and propose an optimal call method. The operation unit can, for example, refer to historical data such as call date and time or call duration. For instance, the operation unit preferentially proposes call methods that the user has frequently used in the past. Additionally, the operation unit can propose an optimal call timing based on the user's past call history. Furthermore, the operation unit can analyze the user's past call history and propose the most efficient call method. Thus, by referring to the user's past call history, the operation unit can propose an optimal call method. Specifically, the operation unit acquires a call history database recorded in the television terminal's storage or a cloud server (e.g., a structured array including call date and time, call duration, call method, success/failure flag, required time, error code, etc.) in chronological order. The operation unit inputs these historical data into a statistical analysis module or AI model (e.g., time-series clustering, LSTM-based history prediction model) to extract user-specific call tendencies (e.g., success rate by day of week and time, frequency of specific call methods, failure patterns, etc.). Examples of AI input include a call history vector for the past 30 days (720 dimensions: 24 hours×30 days), success rates for each call method (video: 0.95, voice: 0.80, etc.), and an array of required call times for the most recent 10 calls. Examples of AI output include recommended call method labels (“video,” “voice,” “group,” etc.), recommended call timing (e.g., today at 19:00), call success probability score (0.0-1.0), and recommended waiting time (in seconds). These outputs are used for subsequent processing such as automatic selection by the call control module, proposals of call method and timing to the user, and call failure risk warnings. As a technical effect, the operation unit can greatly improve call efficiency, success rate, and user experience by combining AI-based history analysis, pattern extraction, and prediction, compared to conventional simple history reference or manual user selection. Application fields include automatic call optimization for home television terminals, reliability improvement for remote medical terminals, call congestion avoidance in educational settings, and reduction of call failures for assistive terminals for disabled persons. With these configurations, the operation unit goes beyond mere automation of human tasks, technically advances the call control function of television terminals, and can revolutionize the efficiency and reliability of the entire system.

The operation unit can estimate the user's emotion and adjust the message display method based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the message display method according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is nervous, the operation unit provides a display method with calm colors to reduce visual stress. If the user is enjoying themselves, the operation unit provides a display method with bright colors to make the display more enjoyable. Furthermore, if the user is tired, the operation unit provides a simple and highly visible display method to facilitate display. Thus, by adjusting the message display method according to the user's emotion, the operation unit enables more appropriate message display. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit inputs these data into convolutional neural networks (CNN) and time-series analysis models (LSTM, Transformer-based voice emotion recognition models) to extract facial features and voice features (MFCC, spectrogram, etc.). The extracted features are input into a multilayer perceptron or multimodal fusion network to output emotion labels (“nervous,” “enjoyment,” “fatigue,” etc.), emotion scores (continuous values from 0.0 to 1.0), and recommended display settings (“calm color scheme,” “bright color scheme,” “simple UI,” etc.). Examples of AI input include facial image tensors (112×112×3), voice spectrograms (128×128 float array), and multimodal feature vectors (concatenated face and voice vectors). Examples of AI output include emotion labels (“nervous,” “enjoyment,” “fatigue”), emotion scores (e.g., 0.85), and recommended display settings (“calm color scheme,” “bright color scheme,” “simple UI,” etc.). The operation unit inputs these output values into threshold judgment logic or rule-based engines to determine specific display adjustment parameters, such as “if nervous score is 0.7 or higher, use calm colors,” “if enjoyment, use bright colors,” “if fatigue, use simple UI,” etc. Furthermore, the operation unit can collaborate with the user's past emotion estimation history and display history database to perform individual optimization (personalization). For AI model training, cross-entropy loss functions and Adam optimizers are used, and pre-training is performed on datasets of thousands to tens of thousands of facial images and voice data. In subsequent processing, display engine parameters are set according to recommended display settings, and UI color, layout, font size, etc. are automatically adjusted in real time. As a technical effect, the operation unit can reduce psychological burden and decrease display errors and stress by realizing automatic display adjustment based on real-time, high-precision emotion estimation, without relying on conventional fixed display or manual user settings. Application fields include accessibility optimization for elderly or disabled persons, display adjustment according to patient psychological state in remote medical terminals, display optimization according to children's concentration in educational support terminals, and emotion-linked display provision in family communication terminals. With these configurations and processes, the operation unit goes beyond mere automation of human tasks, technically advances the display control function of television terminals, and can revolutionize the user experience.

The operation unit can refer to the user's past display history at the time of message display and propose an optimal display method. The operation unit can, for example, refer to historical data such as display date and time or display content. For instance, the operation unit preferentially proposes display methods that the user has frequently used in the past. Additionally, the operation unit can propose an optimal display timing based on the user's past display history. Furthermore, the operation unit can analyze the user's past display history and propose the most efficient display method. Thus, by referring to the user's past display history, the operation unit can propose an optimal display method. Specifically, the operation unit acquires a display history database recorded in the television terminal's storage or a cloud server (e.g., a structured array including display date and time, display content type, display method, success/failure flag, required time, error code, etc.) in chronological order. The operation unit inputs these historical data into a statistical analysis module or AI model (e.g., time-series clustering, LSTM-based history prediction model) to extract user-specific display tendencies (e.g., success rate by day of week and time, frequency of specific display methods, failure patterns, etc.). Examples of AI input include a display history vector for the past 30 days (720 dimensions: 24 hours ×30 days), success rates for each display method (large screen: 0.95, sidebar: 0.80, etc.), and an array of required display times for the most recent 10 displays. Examples of AI output include recommended display method labels (“large screen,” “sidebar,” “popup,” etc.), recommended display timing (e.g., today at 19:00), display success probability score (0.0-1.0), and recommended waiting time (in seconds). These outputs are used for subsequent processing such as automatic selection by the display control module, proposals of display method and timing to the user, and display failure risk warnings. As a technical effect, the operation unit can greatly improve display efficiency, success rate, and user experience by combining AI-based history analysis, pattern extraction, and prediction, compared to conventional simple history reference or manual user selection. Application fields include automatic display optimization for home television terminals, reliability improvement for remote medical terminals, display congestion avoidance in educational settings, and reduction of display failures for assistive terminals for disabled persons. With these configurations, the operation unit goes beyond mere automation of human tasks, technically advances the display control function of television terminals, and can revolutionize the efficiency and reliability of the entire system.

The operation unit can estimate the user's emotion and adjust the timing of confirming safety or checking health status based on the estimated emotion. The operation unit can, for example, estimate the user's emotion using facial recognition or voice analysis. For instance, the operation unit captures the user's facial expression with a camera and estimates the emotion using an emotion estimation algorithm. Additionally, the operation unit can record the user's voice with a microphone and estimate the emotion using voice analysis technology. Thus, the operation unit can adjust the timing of confirming safety or checking health status according to the user's emotion. Emotion estimation is realized, for example, by using an emotion engine or generative AI with emotion estimation functions. Generative AI may include text generation AI (e.g., LLM) or multimodal generative AI, but is not limited to these examples. For example, if the user is relaxed, the operation unit delays the timing of confirming safety or checking health status to provide the user with time to prepare. If the user is in a hurry, the operation unit advances the timing for rapid checking. Furthermore, if the user is feeling anxious, the operation unit adjusts the timing to help the user feel at ease. Thus, by adjusting the timing of confirming safety or checking health status according to the user's emotion, the operation unit enables more appropriate checking. Specifically, the operation unit acquires facial images (112×112×3 RGB tensor) from a camera device connected to the television and voice waveform data (16 kHz, 16 bit PCM format, 16,000 samples per second as a float array) from a microphone device as input data. The operation unit inputs these data into convolutional neural networks (CNN) and time-series analysis models (LSTM, Transformer-based voice emotion recognition models) to extract facial features and voice features (MFCC, spectrogram, etc.). The extracted features are input into a multilayer perceptron or multimodal fusion network to output emotion labels (“relaxation,” “hurry,” “anxiety,” etc.), emotion scores (continuous values from 0.0 to 1.0), and recommended checking timing (delay value in seconds). Examples of AI input include facial image tensors (112×112×3), voice spectrograms (128×128 float array), and multimodal feature vectors (concatenated face and voice vectors). Examples of AI output include emotion labels (“relaxation,” “hurry,” “anxiety”), emotion scores (e.g., 0.85), and recommended checking timing (e.g., 5 seconds delay, immediate checking). The operation unit inputs these output values into threshold judgment logic or rule-based engines to determine specific timing adjustment parameters, such as “if relaxation, 10 seconds delay,” “if hurry, immediate checking,” etc. Furthermore, the operation unit can collaborate with the user's past emotion estimation history and checking success rate database to perform individual optimization (personalization). For AI model training, cross-entropy loss functions and Adam optimizers are used, and pre-training is performed on datasets of thousands to tens of thousands of facial images and voice data. In subsequent processing, checking processing is submitted to the scheduler according to the recommended timing, and checking preparation notifications or reassurance messages are displayed to the user. As a technical effect, the operation unit can reduce psychological burden and decrease checking failures and stress by realizing checking timing control based on real-time, high-precision emotion estimation, without relying on conventional simple timers or manual user operation. Application fields include reassurance checking control in elderly monitoring systems, checking timing control according to patient psychological state in remote medical care, checking control according to children's concentration in educational support terminals, and stress-free checking experience in assistive terminals for disabled persons. With these configurations and processes, the operation unit goes beyond mere automation of human tasks, technically advances the health checking control function of television terminals, and can revolutionize the user experience.

The operation unit can refer to the user's past health data at the time of confirming safety or checking health status and propose an optimal checking method. The operation unit can, for example, refer to health data such as blood pressure or heart rate. For instance, the operation unit preferentially proposes checking methods that the user has frequently used in the past. Additionally, the operation unit can propose an optimal checking timing based on the user's past health data. Furthermore, the operation unit can analyze the user's past health data and propose the most efficient checking method. Thus, by referring to the user's past health data, the operation unit can propose an optimal checking method. Specifically, the operation unit acquires a health database recorded in the television terminal's storage or a cloud server (e.g., a structured array including blood pressure, heart rate, body temperature, measurement date and time, checking method, success/failure flag, required time, error code, etc.) in chronological order. The operation unit inputs these health data into a statistical analysis module or AI model (e.g., time-series clustering, LSTM-based history prediction model) to extract user-specific health checking tendencies (e.g., success rate by day of week and time, frequency of specific checking methods, failure patterns, etc.). Examples of AI input include a health data vector for the past 30 days (720 dimensions: 24 hours×30 days), success rates for each checking method (blood pressure: 0.95, heart rate: 0.80, etc.), and an array of required checking times for the most recent 10 checks. Examples of AI output include recommended checking method labels (“blood pressure,” “heart rate,” “body temperature,” etc.), recommended checking timing (e.g., today at 19:00), checking success probability score (0.0-1.0), and recommended waiting time (in seconds). These outputs are used for subsequent processing such as automatic selection by the checking control module, proposals of checking method and timing to the user, and checking failure risk warnings. As a technical effect, the operation unit can greatly improve checking efficiency, success rate, and user experience by combining AI-based health data analysis, pattern extraction, and prediction, compared to conventional simple history reference or manual user selection. Application fields include automatic health checking optimization for home television terminals, reliability improvement for remote medical terminals, health monitoring in educational settings, and reduction of health checking failures for assistive terminals for disabled persons. With these configurations, the operation unit goes beyond mere automation of human tasks, technically advances the health checking control function of television terminals, and can revolutionize the efficiency and reliability of the entire system.

The system according to the embodiment is not limited to the examples described above and can be variously modified as follows, for example. Specifically, the present system is not limited to the combination of a television terminal and a USB-connected device, and can also be applied to terminal cooperation using various communication interfaces such as wireless LAN (Wi-Fi), Bluetooth, Ethernet, etc. The present system is not limited to messenger applications and can be extended to automatic recognition, startup, and operation of various applications such as video conferencing applications, health management applications, educational support applications, remote medical applications, etc. Regarding AI models, not only single convolutional neural networks or LSTM, but also advanced AI architectures such as Transformer-based large language models, multimodal fusion models, and reinforcement learning agents can be combined and used. From the perspective of data flow, in addition to local processing within the television terminal, advanced data cooperation such as distributed cooperative processing with cloud servers or edge servers, P2P communication between multiple terminals, and real-time streaming analysis can also be realized. Furthermore, as user authentication methods, multi-factor authentication combining facial recognition, voice recognition, fingerprint authentication, password authentication, etc. can be used, enabling enhanced security and privacy protection. Algorithms for AI-based emotion estimation and health status estimation can also apply various learning methods such as supervised learning, semi-supervised learning, self-supervised learning, and transfer learning, thereby improving personalization for each user and adaptability to new data. As a technical effect, the present system can dramatically improve overall system scalability, adaptability, reliability, security, and user experience by flexibly combining various variations of communication interfaces, application types, AI models, data flows, authentication methods, and learning methods. Application fields include smart home cooperation for home television terminals, remote medical care and health management, teaching material distribution and learning support in educational settings, multifunctionalization of assistive terminals for disabled persons, enterprise conference systems, and deployment in all fields. With these configurations, the present system goes beyond mere automation of human tasks and, as a next-generation information processing infrastructure centered on television terminals, can contribute to technological progress for society as a whole.

The connection unit can analyze the user's past connection history and propose an optimal connection timing. For example, the connection unit analyzes past connection success rates and connection times to identify the timing when the user is most likely to connect successfully. Additionally, the connection unit can learn from past connection history that connections are more likely to succeed at specific days or times and preferentially propose those timings. Furthermore, the connection unit can analyze the frequency and patterns of the user's connection attempts based on past connection history and propose optimal connection timings. Thus, by utilizing the user's past connection history, the connection unit can achieve more efficient connections. Specifically, the connection unit acquires a connection history database recorded in the television terminal's storage or a cloud server (e.g., a structured array including connection date and time, connection method, success/failure flag, required connection time, error code, etc.) in chronological order. The connection unit inputs these historical data into a statistical analysis module or AI model (e.g., time-series clustering, LSTM-based history prediction model) to extract user-specific connection tendencies (e.g., success rate by day of week and time, frequency of specific network usage, failure patterns, etc.). Examples of AI input include a connection history vector for the past 30 days (720 dimensions: 24 hours ×30 days), success rates for each connection method (Wi-Fi: 0.95, mobile: 0.80, etc.), and an array of required connection times for the most recent 10 connections. Examples of AI output include recommended connection timing (e.g., today at 19:00), connection success probability score (0.0-1.0), and recommended waiting time (in seconds). These outputs are used for subsequent processing such as automatic selection by the connection control module, proposals of connection timing to the user, and connection failure risk warnings. As a technical effect, the connection unit can greatly improve connection efficiency, success rate, and user experience by combining AI-based history analysis, pattern extraction, and prediction, compared to conventional simple history reference or manual user selection. Application fields include automatic connection optimization for home television terminals, reliability improvement for remote medical communication terminals, network congestion avoidance in educational settings, and reduction of connection failures for assistive terminals for disabled persons. With these configurations, the connection unit goes beyond mere automation of human tasks, technically advances the connection control function of television terminals, and can revolutionize the efficiency and reliability of the entire system.

The operation unit can analyze the user's operation history and propose an optimal operation method. For example, the operation unit analyzes past operation success rates and operation times to identify the method that is easiest for the user to operate. Additionally, the operation unit can learn from past operation history that specific operation procedures or interfaces are easier for the user to use and preferentially propose those methods. Furthermore, the operation unit can analyze the frequency and patterns of the user's operation attempts based on past operation history and propose optimal operation methods. Thus, by utilizing the user's past operation history, the operation unit can achieve more efficient operation. Specifically, the operation unit acquires an operation history database recorded in the television terminal's storage or a cloud server (e.g., a structured array including operation date and time, operation type, success/failure flag, required operation time, error code, etc.) in chronological order. The operation unit inputs these historical data into a statistical analysis module or AI model (e.g., time-series clustering, LSTM-based history prediction model) to extract user-specific operation tendencies (e.g., success rate by day of week and time, frequency of specific operation procedures or interfaces, failure patterns, etc.). Examples of AI input include an operation history vector for the past 30 days (720 dimensions: 24 hours×30 days), success rates for each operation type (remote control: 0.95, voice: 0.80, etc.), and an array of required operation times for the most recent 10 operations. Examples of AI output include recommended operation method labels (“remote control,” “voice,” “touch,” etc.), recommended operation timing (e.g., today at 19:00), operation success probability score (0.0-1.0), and recommended waiting time (in seconds). These outputs are used for subsequent processing such as automatic selection by the operation control module, proposals of operation method and timing to the user, and operation failure risk warnings. As a technical effect, the operation unit can greatly improve operation efficiency, success rate, and user experience by combining AI-based history analysis, pattern extraction, and prediction, compared to conventional simple history reference or manual user selection. Application fields include automatic operation optimization for home television terminals, reliability improvement for remote medical terminals, operation congestion avoidance in educational settings, and reduction of operation failures for assistive terminals for disabled persons. With these configurations, the operation unit goes beyond mere automation of human tasks, technically advances the operation control function of television terminals, and can revolutionize the efficiency and reliability of the entire system.

The operation unit can estimate a user's emotion and customize the operation interface based on the estimated emotion. For example, when the user is nervous, the operation unit provides an interface with calm colors to reduce visual stress. When the user is enjoying themselves, the operation unit can provide an interface with bright colors to make the operation more enjoyable. Furthermore, when the user is tired, the operation unit can provide a simple and highly visible interface to facilitate operation. By customizing the operation interface according to the user's emotion, the operation unit enables more appropriate operation. Specifically, the operation unit acquires input data such as facial images (112×112×3 RGB tensor) obtained from a camera device connected to the television and audio waveform data (16 kHz, 16 bit PCM format, 16,000 samples per second float array) obtained from a microphone device. The operation unit inputs these data into convolutional neural networks (CNN) or time-series analysis models (LSTM, Transformer-based speech emotion recognition models) to extract facial features and audio features (MFCC, spectrogram, etc.). The operation unit inputs the extracted features into multilayer perceptrons or multimodal fusion networks to output emotion labels (such as “nervous,” “enjoyment,” “fatigue”), emotion scores (continuous values from 0.0 to 1.0), and recommended UI settings (such as “calm color scheme,” “bright color scheme,” “simple UI”). Examples of AI input include facial image tensors (112×112×3), audio spectrograms (128×128 float array), and multimodal feature vectors (concatenated face and audio vectors). Examples of AI output include emotion labels (“nervous,” “enjoyment,” “fatigue”), emotion scores (e.g., 0.85), and recommended UI settings (“calm color scheme,” “bright color scheme,” “simple UI”). The operation unit inputs these output values into threshold judgment logic or rule-based engines to determine specific UI adjustment parameters, such as “if the nervous score is 0.7 or higher, use a calm color scheme,” “if enjoyment, use a bright color scheme,” “if fatigue, use a simple UI.” Furthermore, the operation unit can collaborate with databases of the user's past emotion estimation history and UI usage history to perform individual optimization (personalization). For AI model training, cross-entropy loss functions and Adam optimizers are used, and pre-training is performed on datasets of thousands to tens of thousands of facial images and audio data. In subsequent processing, the recommended UI settings are input into the interface rendering engine, which automatically adjusts UI color, layout, font size, etc., in real time. As a technical effect, the operation unit achieves automatic interface adjustment based on real-time and highly accurate emotion estimation, without relying on conventional fixed UI display or manual user settings, thereby reducing the user's psychological burden and decreasing operational errors and stress. Application fields include accessibility optimization for elderly or disabled persons, UI adjustment according to patient psychological state in remote medical terminals, UI optimization according to children's concentration in educational support terminals, and emotion-linked UI provision in family communication terminals. Through these configurations and processes, the operation unit goes beyond mere automation of human tasks, technologically advances the operation interface functions of television terminals, and revolutionizes the user experience.

The connection unit can select an optimal connection method by considering the user's geographic location information. For example, the connection unit can acquire the user's geographic location information using GPS data or IP addresses. When the user is at home, Wi-Fi connection is prioritized. When the user is outside, mobile data connection can be prioritized. Furthermore, when the user is in a public place, a secure connection method can be selected. By selecting the optimal connection method according to the user's geographic location information, the connection unit improves connection efficiency. Specifically, the connection unit acquires input data such as GPS modules connected to the television or IP address information obtained from the network interface. For GPS data, a structure including latitude, longitude, altitude, and timestamp (e.g., lat: 35.6, lon: 139.7, alt: 10.2, time: 2024-06-01T10:00:00Z) is used, and for IP addresses, the GeoIP database is referenced to identify regional information (country, prefecture, city level). Based on this location information, the connection unit scans candidate networks (Wi-Fi SSID list, mobile data APN list, public wireless LAN list, etc.) and extracts features such as security level (WPA2, WPA3, open, etc.), signal strength (RSSI value), bandwidth, and past connection success rates. When incorporating AI processing, the connection unit uses classification models (random forest, LightGBM, DNN, etc.) with location information, network characteristics, and user history as input to infer the optimal connection method (Wi-Fi, mobile data, public LAN, etc.). Examples of AI input include current location latitude and longitude (2D float), Wi-Fi RSSI value array (5 items), and connection success flag array for the past 24 hours (24 dimensions). Examples of AI output include recommended connection method labels (“Wi-Fi,” “mobile data,” “public LAN”), recommended connection destination ID (SSID or APN name), and connection success probability score (0.0 to 1.0). These outputs are used for automatic selection by the connection control module, connection method proposals to the user, and security warning displays in subsequent processing. As a technical effect, the connection unit can greatly improve connection efficiency, security, and user experience by combining real-time location information, network characteristics, and AI prediction, compared to conventional simple network selection or manual user operation. Application fields include automatic network switching for home television terminals, secure communication path assurance for remote medical terminals, roaming support in educational settings, and automatic connection optimization for assistive devices for disabled persons. Through these configurations, the connection unit goes beyond mere automation of human tasks, technologically advances the connection control functions of television terminals, and revolutionizes the efficiency and reliability of the entire system.

The operation unit can estimate a user's emotion and adjust the message transmission timing based on the estimated emotion. For example, when the user is relaxed, the operation unit delays the message transmission timing to provide the user with time to prepare. When the user is in a hurry, the operation unit can expedite the message transmission timing for rapid sending. Furthermore, when the user feels anxious, the operation unit can adjust the message transmission timing to help the user feel at ease. By adjusting the message transmission timing according to the user's emotion, the operation unit enables more appropriate message transmission. Specifically, the operation unit acquires input data such as facial images (112×112×3 RGB tensor) obtained from a camera device connected to the television and audio waveform data (16 kHz, 16 bit PCM format, 16,000 samples per second float array) obtained from a microphone device. The operation unit inputs these data into convolutional neural networks (CNN) or time-series analysis models (LSTM, Transformer-based speech emotion recognition models) to extract facial features and audio features (MFCC, spectrogram, etc.). The operation unit inputs the extracted features into multilayer perceptrons or multimodal fusion networks to output emotion labels (such as “relaxed,” “hurry,” “anxiety”), emotion scores (continuous values from 0.0 to 1.0), and recommended transmission timing (delay value in seconds). Examples of AI input include facial image tensors (112×112×3), audio spectrograms (128×128 float array), and multimodal feature vectors (concatenated face and audio vectors). Examples of AI output include emotion labels (“relaxed,” “hurry,” “anxiety”), emotion scores (e.g., 0.85), and recommended transmission timing (e.g., 5 seconds delay, immediate transmission). The operation unit inputs these output values into threshold judgment logic or rule-based engines to determine specific timing adjustment parameters, such as “if relaxed, delay by 10 seconds,” “if in a hurry, transmit immediately.” Furthermore, the operation unit can collaborate with databases of the user's past emotion estimation history and transmission success rate to perform individual optimization (personalization). For AI model training, cross-entropy loss functions and Adam optimizers are used, and pre-training is performed on datasets of thousands to tens of thousands of facial images and audio data. In subsequent processing, the recommended timing is input into the transmission scheduler, and transmission preparation notifications or reassurance messages are displayed to the user. As a technical effect, the operation unit achieves transmission timing control based on real-time and highly accurate emotion estimation, without relying on conventional simple timers or manual user operation, thereby reducing the user's psychological burden and decreasing transmission failures and stress. Application fields include secure transmission control in elderly monitoring systems, transmission timing control according to patient psychological state in remote medical care, transmission control according to children's concentration in educational support terminals, and stress-free transmission experience in assistive devices for disabled persons. Through these configurations and processes, the operation unit goes beyond mere automation of human tasks, technologically advances the message transmission control functions of television terminals, and revolutionizes the user experience.

The connection unit can perform filtering at the time of connection to avoid interference with other connected devices of the television. For example, filtering can be performed to avoid Wi-Fi or Bluetooth interference. When other USB devices are connected, the connection unit adjusts the connection to avoid interference with those devices. Additionally, when HDMI devices are connected, the connection unit can also adjust the connection to avoid interference with those devices. Furthermore, when Bluetooth devices are connected, the connection unit can also adjust the connection to avoid interference with those devices. By avoiding interference with other connected devices, the connection unit improves connection stability. Specifically, the connection unit uses the television's hardware abstraction layer API to acquire the connection status of USB ports (device ID for each port, bus power consumption), HDMI ports (EDID information, resolution, bandwidth usage), and Wi-Fi/Bluetooth module channel usage (channel number in 2.4 GHz/5 GHz bands, RSSI value, connected device MAC address) in real time. The connection unit manages this information as a device management table (structure storing type, status, and priority of various devices) and executes interference determination algorithms (channel overlap detection, bus power excess detection, bandwidth competition determination). For example, if Wi-Fi and Bluetooth are using the same 2.4 GHz channel, Bluetooth connection is temporarily suspended; if USB devices exceed the bus power limit, new connections are delayed. When incorporating AI processing, the connection unit can use classification models (random forest, LightGBM, DNN, etc.) trained on past device interference history (device combinations at connection failure, channel usage, error codes) to predict interference occurrence probability. Examples of AI input include current device connection state vectors (USB: 4 bits, HDMI: 2 bits, Wi-Fi: 8 bits, Bluetooth: 8 bits, etc.), and interference occurrence flag arrays for the past 24 hours (24 dimensions). Examples of AI output include interference risk score (0.0 to 1.0), recommended connection timing (e.g., after 5 seconds), and priority connection device ID (e.g., USB1). These outputs are used for automatic control by the connection scheduler, connection order proposals to the user, and automatic reconnection processing to avoid interference in subsequent processing. As a technical effect, the connection unit can greatly improve connection stability, communication quality, and user experience by combining real-time hardware state monitoring, AI-based interference prediction, and automatic filtering, compared to conventional simple device connection control. Application fields include multi-device connection control for home television terminals, communication stabilization for remote medical terminals, simultaneous use of multiple terminals in educational settings, and reliability improvement for assistive devices for disabled persons. Through these configurations, the connection unit goes beyond mere automation of human tasks, technologically advances the device connection management functions of television terminals, and revolutionizes the stability and reliability of the entire system.

The operation unit can estimate a user's emotion and adjust the timing of starting a video call based on the estimated emotion. For example, when the user is relaxed, the operation unit delays the video call start timing to provide the user with time to prepare. When the user is in a hurry, the operation unit can expedite the video call start timing for rapid calling. Furthermore, when the user feels anxious, the operation unit can adjust the video call start timing to help the user feel at ease. By adjusting the video call start timing according to the user's emotion, the operation unit enables more appropriate video calls. Specifically, the operation unit acquires input data such as facial images (112×112×3 RGB tensor) obtained from a camera device connected to the television and audio waveform data (16 kHz, 16 bit PCM format, 16,000 samples per second float array) obtained from a microphone device. The operation unit inputs these data into convolutional neural networks (CNN) or time-series analysis models (LSTM, Transformer-based speech emotion recognition models) to extract facial features and audio features (MFCC, spectrogram, etc.). The operation unit inputs the extracted features into multilayer perceptrons or multimodal fusion networks to output emotion labels (such as “relaxed,” “hurry,” “anxiety”), emotion scores (continuous values from 0.0 to 1.0), and recommended call start timing (delay value in seconds). Examples of AI input include facial image tensors (112×112×3), audio spectrograms (128×128 float array), and multimodal feature vectors (concatenated face and audio vectors). Examples of AI output include emotion labels (“relaxed,” “hurry,” “anxiety”), emotion scores (e.g., 0.85), and recommended call start timing (e.g., 5 seconds delay, immediate start). The operation unit inputs these output values into threshold judgment logic or rule-based engines to determine specific timing adjustment parameters, such as “if relaxed, delay by 10 seconds,” “if in a hurry, start immediately.” Furthermore, the operation unit can collaborate with databases of the user's past emotion estimation history and call success rate to perform individual optimization (personalization). For AI model training, cross-entropy loss functions and Adam optimizers are used, and pre-training is performed on datasets of thousands to tens of thousands of facial images and audio data. In subsequent processing, the recommended timing is input into the call start scheduler, and call preparation notifications or reassurance messages are displayed to the user. As a technical effect, the operation unit achieves call start timing control based on real-time and highly accurate emotion estimation, without relying on conventional simple timers or manual user operation, thereby reducing the user's psychological burden and decreasing call failures and stress. Application fields include secure call control in elderly monitoring systems, call timing control according to patient psychological state in remote medical care, call control according to children's concentration in educational support terminals, and stress-free call experience in assistive devices for disabled persons. Through these configurations and processes, the operation unit goes beyond mere automation of human tasks, technologically advances the call control functions of television terminals, and revolutionizes the user experience.

The operation unit can refer to the user's past operation history to propose an optimal operation method. For example, the operation unit can refer to history data such as operation date and time and operation success rate. The operation unit prioritizes proposing operation methods that the user has frequently used in the past. Additionally, the operation unit can propose optimal operation timing based on the user's past operation history. Furthermore, the operation unit can analyze the user's past operation history to propose the most efficient operation method. By referring to the user's past operation history, the operation unit can propose the optimal operation method. Specifically, the operation unit acquires operation history databases (structure arrays including operation date and time, operation type, success/failure flag, operation duration, error code, etc.) recorded in the television terminal's storage or cloud server in chronological order. The operation unit inputs these history data into statistical analysis modules or AI models (time-series clustering, LSTM-based history prediction models, etc.) to extract operation tendencies for each user (success rate by day of week and time, frequency of specific operations, failure patterns, etc.). Examples of AI input include operation history vectors for the past 30 days (720 dimensions: 24 hours ×30 days), success rates for each operation type (remote controller: 0.95, voice: 0.80, etc.), and arrays of operation durations for the last 10 operations. Examples of AI output include recommended operation method labels (“remote controller,” “voice,” “touch,” etc.), recommended operation timing (e.g., today at 19:00), operation success probability score (0.0 to 1.0), and recommended waiting time (in seconds). The operation unit uses these output values for automatic selection by the operation control module, proposals of operation methods and timing to the user, and risk warnings for operation failure in subsequent processing. As a technical effect, the operation unit can greatly improve operation efficiency, success rate, and user experience by combining AI-based history analysis, pattern extraction, and prediction, compared to conventional simple history reference or manual user selection. Application fields include automatic operation optimization for home television terminals, improved operation reliability for remote medical terminals, congestion avoidance in educational settings, and reduction of operation failures for assistive devices for disabled persons. Through these configurations, the operation unit goes beyond mere automation of human tasks, technologically advances the operation control functions of television terminals, and revolutionizes the efficiency and reliability of the entire system.

The operation unit can estimate a user's emotion and adjust the message display method based on the estimated emotion. For example, when the user is nervous, the operation unit provides a display method with calm colors to reduce visual stress. When the user is enjoying themselves, the operation unit can provide a display method with bright colors to make the display more enjoyable. Furthermore, when the user is tired, the operation unit can provide a simple and highly visible display method to facilitate display. By adjusting the message display method according to the user's emotion, the operation unit enables more appropriate message display. Specifically, the operation unit acquires input data such as facial images (112×112×3 RGB tensor) obtained from a camera device connected to the television and audio waveform data (16 kHz, 16 bit PCM format, 16,000 samples per second float array) obtained from a microphone device. The operation unit inputs these data into convolutional neural networks (CNN) or time-series analysis models (LSTM, Transformer-based speech emotion recognition models) to extract facial features and audio features (MFCC, spectrogram, etc.). The operation unit inputs the extracted features into multilayer perceptrons or multimodal fusion networks to output emotion labels (such as “nervous,” “enjoyment,” “fatigue”), emotion scores (continuous values from 0.0 to 1.0), and recommended display settings (such as “calm color scheme,” “bright color scheme,” “simple UI”). Examples of AI input include facial image tensors (112×112×3), audio spectrograms (128×128 float array), and multimodal feature vectors (concatenated face and audio vectors). Examples of AI output include emotion labels (“nervous,” “enjoyment,” “fatigue”), emotion scores (e.g., 0.85), and recommended display settings (“calm color scheme,” “bright color scheme,” “simple UI”). The operation unit inputs these output values into threshold judgment logic or rule-based engines to determine specific display adjustment parameters, such as “if the nervous score is 0.7 or higher, use a calm color scheme,” “if enjoyment, use a bright color scheme,” “if fatigue, use a simple UI.” Furthermore, the operation unit can collaborate with databases of the user's past emotion estimation history and display history to perform individual optimization (personalization). For AI model training, cross-entropy loss functions and Adam optimizers are used, and pre-training is performed on datasets of thousands to tens of thousands of facial images and audio data. In subsequent processing, the recommended display settings are input into the display engine, which automatically adjusts UI color, layout, font size, etc., in real time. As a technical effect, the operation unit achieves automatic display adjustment based on real-time and highly accurate emotion estimation, without relying on conventional fixed display or manual user settings, thereby reducing the user's psychological burden and decreasing display errors and stress. Application fields include accessibility optimization for elderly or disabled persons, display adjustment according to patient psychological state in remote medical terminals, display optimization according to children's concentration in educational support terminals, and emotion-linked display provision in family communication terminals. Through these configurations and processes, the operation unit goes beyond mere automation of human tasks, technologically advances the display control functions of television terminals, and revolutionizes the user experience.

The connection unit can analyze the user's past connection history at the time of connection and propose an optimal connection method. For example, the connection unit can analyze history data such as connection date and time and connection success rate. The connection unit prioritizes proposing connection methods that the user has frequently used in the past. Additionally, the connection unit can propose optimal connection timing based on the user's past connection history. Furthermore, the connection unit can analyze the user's past connection history to propose the most efficient connection method. By analyzing the user's past connection history, the connection unit can propose the optimal connection method. Specifically, the connection unit acquires connection history databases (structure arrays including connection date and time, connection method, success/failure flag, connection duration, error code, etc.) recorded in the television terminal's storage or cloud server in chronological order. The connection unit inputs these history data into statistical analysis modules or AI models (time-series clustering, LSTM-based history prediction models, etc.) to extract connection tendencies for each user (success rate by day of week and time, frequency of specific networks, failure patterns, etc.). Examples of AI input include connection history vectors for the past 30 days (720 dimensions: 24 hours×30 days), success rates for each connection method (Wi-Fi: 0.95, mobile: 0.80, etc.), and arrays of connection durations for the last 10 connections. Examples of AI output include recommended connection method labels (“Wi-Fi,” “mobile data,” etc.), recommended connection timing (e.g., today at 19:00), connection success probability score (0.0 to 1.0), and recommended waiting time (in seconds). The connection unit uses these output values for automatic selection by the connection control module, proposals of connection methods and timing to the user, and risk warnings for connection failure in subsequent processing. As a technical effect, the connection unit can greatly improve connection efficiency, success rate, and user experience by combining AI-based history analysis, pattern extraction, and prediction, compared to conventional simple history reference or manual user selection. Application fields include automatic connection optimization for home television terminals, improved communication reliability for remote medical terminals, network congestion avoidance in educational settings, and reduction of connection failures for assistive devices for disabled persons. Through these configurations, the connection unit goes beyond mere automation of human tasks, technologically advances the connection control functions of television terminals, and revolutionizes the efficiency and reliability of the entire system.

The following is a brief explanation of the processing flow of Example of the Embodiment. Specifically, the present system is initiated by the cooperation between the television terminal and the USB-connected device, and the connection unit, startup unit, and operation unit modules operate in coordination. The connection unit acquires the vendor ID and product ID of the USB device, file system structure, application signature information, etc., as byte arrays and parses them with a dedicated device driver module. The startup unit determines the validity of the application by combining algorithms such as signature verification, file hash matching, and version checking, and launches the application launcher on the television OS. The operation unit receives remote controller input signals via an event handler and provides functions such as sending and receiving messages, media sharing, and video calls. When incorporating AI processing, each unit inputs high-dimensional data such as image tensors, audio waveforms, and time-series history vectors into neural networks such as CNN, LSTM, and Transformer for feature extraction, classification, and prediction, and inputs output values (labels, scores, recommended values, etc.) into subsequent control logic or UI rendering engines. As a result, the entire system goes beyond conventional simple automation of human tasks, technologically advances the communication, operation, display, and connection management functions of television terminals, and revolutionizes user experience, system efficiency, and reliability.

Step 1: The connection unit connects a mobile terminal equipped with a USB-type messenger application to a USB port of a television. For example, the connection unit can use a port compatible with USB 2.0 or USB 3.0 standards. Specifically, the connection unit acquires the physical connection status of the USB port (port number, power supply status, device ID, vendor ID, product ID, USB protocol version, etc.) as a byte array via the hardware abstraction layer API of the television terminal. The connection unit parses the acquired byte array with a dedicated device driver module to determine whether the terminal supports USB mass storage class, MTP (Media Transfer Protocol), or a custom protocol. Furthermore, the connection unit extracts the terminal's file system structure (FAT32, exFAT, NTFS, etc.) and application signature information (SHA-256 hash value, signature algorithm type, etc.) to perform security checks and compatibility determination. When incorporating AI processing, the connection unit inputs past connection history data (connection date and time, device type, success/failure flag, error code, etc.) and real-time hardware state vectors (connection status for each USB port, bus power consumption, bandwidth usage, etc.) into models such as LSTM or random forest to predict connection success probability and interference risk. Examples of AI input include USB port state vectors (8 bits×4 ports), connection success flag arrays for the past 24 hours (24 dimensions), and one-hot vectors for device IDs (16 dimensions). Examples of AI output include recommended connection port number (e.g., port 2), connection success probability score (0.0 to 1.0), and interference risk score (0.0 to 1.0). These outputs are used for automatic port selection by the connection control module, connection proposals to the user, and interference avoidance processing in subsequent steps. Step 2: The startup unit recognizes the terminal connected by the connection unit and launches the messenger application. For example, the startup unit uses software embedded in the television firmware to automatically detect the connected terminal and launch the messenger application. Specifically, the startup unit mounts the USB device's file system and scans for the presence of application signature files and executable files (e.g., .apk, .exe, .bin, etc.). The startup unit combines signature verification algorithms (RSA, ECDSA, etc.), file hash matching (SHA-256, SHA-512, etc.), and version checking (metadata analysis) to determine the validity, safety, and compatibility of the application. When incorporating AI processing, the startup unit inputs past application startup history (startup date and time, application ID, success/failure flag, error code, etc.) and terminal state vectors (CPU load, available memory, OS version, etc.) into models such as DNN or LightGBM to predict startup success probability and recommended startup timing. Examples of AI input include one-hot vectors for application IDs (32 dimensions), terminal state vectors (CPU: 4 dimensions, memory: 2 dimensions, etc.), and startup success flag arrays for the last 10 startups (10 dimensions). Examples of AI output include recommended startup timing (e.g., immediate, after 5 seconds), startup success probability score (0.0 to 1.0), and recommended application ID (e.g., application 3). These outputs are used for application startup scheduling, user notifications, and error avoidance processing in subsequent steps. Step 3: The operation unit operates the messenger application launched by the startup unit using a remote controller. For example, the operation unit can operate the messenger application's interface using an infrared remote controller or Bluetooth remote controller. The operation unit provides functions such as sending and receiving messages, sharing photos or videos, and video calls. Specifically, the operation unit receives remote controller input signals (button ID, press duration, continuous input pattern, etc.) via an event handler and inputs them into the application's UI event queue. The operation unit collaborates with the UI rendering engine to control various operations in real time, such as screen transitions, message input, media selection, and call initiation. When incorporating AI processing, the operation unit inputs user operation history data (operation date and time, operation type, success/failure flag, duration, etc.) and real-time operation state vectors (current screen ID, input waiting state, error occurrence flag, etc.) into models such as LSTM or Transformer to predict recommended operation methods and operation success probability. Examples of AI input include operation history vectors for the past 30 days (720 dimensions), current screen state vectors (16 dimensions), and remote controller input pattern vectors (8 dimensions). Examples of AI output include recommended operation method labels (“remote controller,” “voice,” “touch,” etc.), recommended operation timing (e.g., today at 19:00), and operation success probability score (0.0 to 1.0). These outputs are used for automatic selection by the operation control module, operation method proposals to the user, and error avoidance processing in subsequent steps. As a technical effect, the present system combines AI-based history analysis, state prediction, and automatic optimization at each stage of USB connection, application startup, and remote controller operation, thereby technologically advancing the connection, application startup, and operation control functions of television terminals beyond conventional simple automation of human tasks, and revolutionizing the efficiency, reliability, and user experience of the entire system. Application fields include multi-device cooperation for home television terminals, secure application startup and operation for remote medical terminals, automatic startup and operation support for educational applications in educational settings, and operation optimization for assistive devices for disabled persons. Through these configurations, the present system technologically evolves the information processing infrastructure of television terminals initiated by USB connection and contributes to improving convenience and reliability for society as a whole.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described connection unit, startup unit, and operation unit is implemented by at least one of, for example, the smart device 14 and the data processing apparatus 12. For example, the connection unit connects a USB-type messenger application mobile terminal using the USB port of the smart device 14. The startup unit recognizes the terminal connected by the control unit 46A of the smart device 14 and launches the messenger application. The operation unit can operate the interface of the messenger application using the remote controller of the smart device 14. The correspondence between each unit and the device or control unit is not limited to the above examples and various modifications are possible.

### Second Embodiment

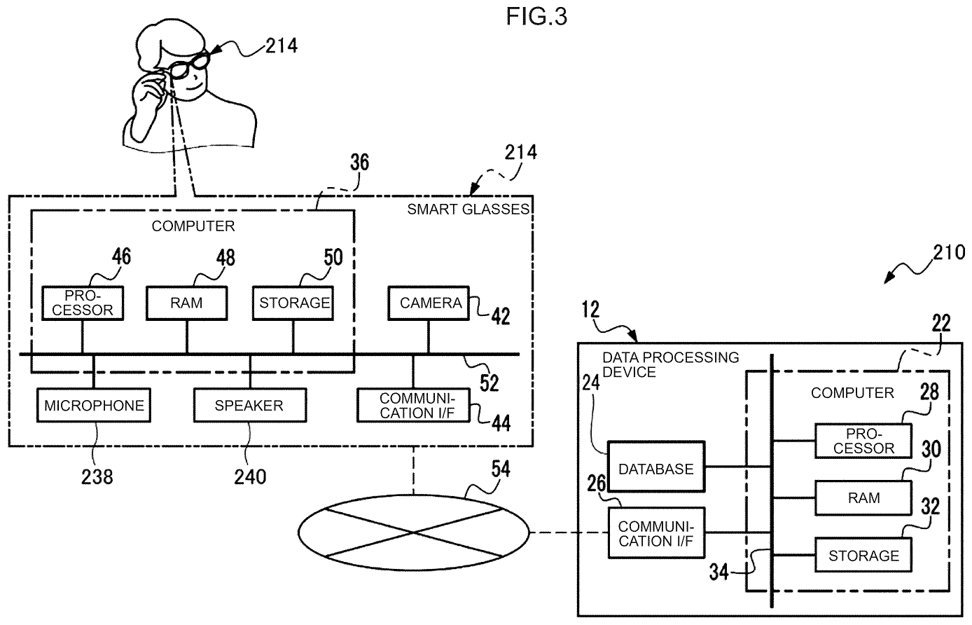

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

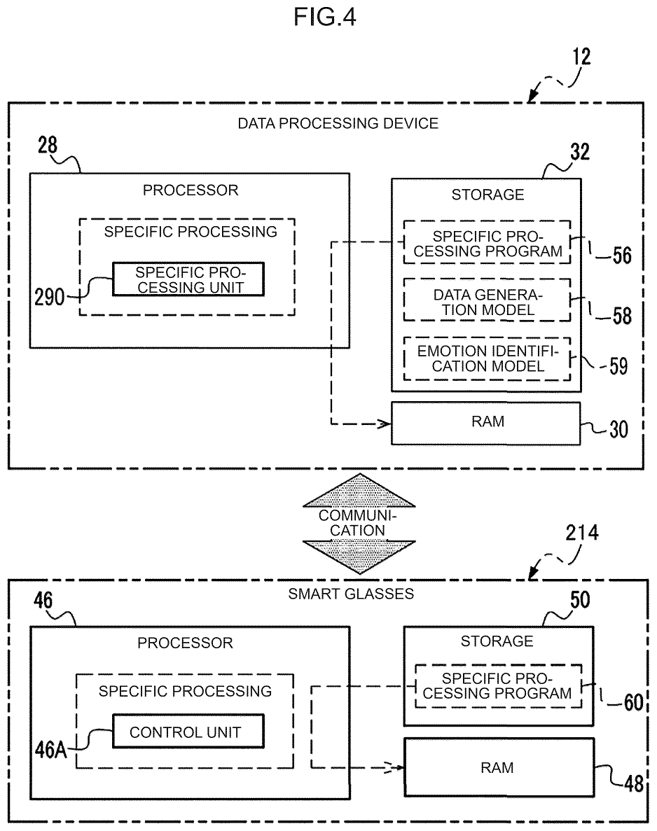

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described connection unit, startup unit, and operation unit is implemented by at least one of, for example, the smart glasses 214 and the data processing apparatus 12. For example, the connection unit connects a USB-type messenger application mobile terminal using the USB port of the smart glasses 214. The startup unit recognizes the terminal connected by the control unit 46A of the smart glasses 214 and launches the messenger application. The operation unit can operate the interface of the messenger application using the remote controller of the smart glasses 214. The correspondence between each unit and the device or control unit is not limited to the above examples and various modifications are possible.

### Third Embodiment

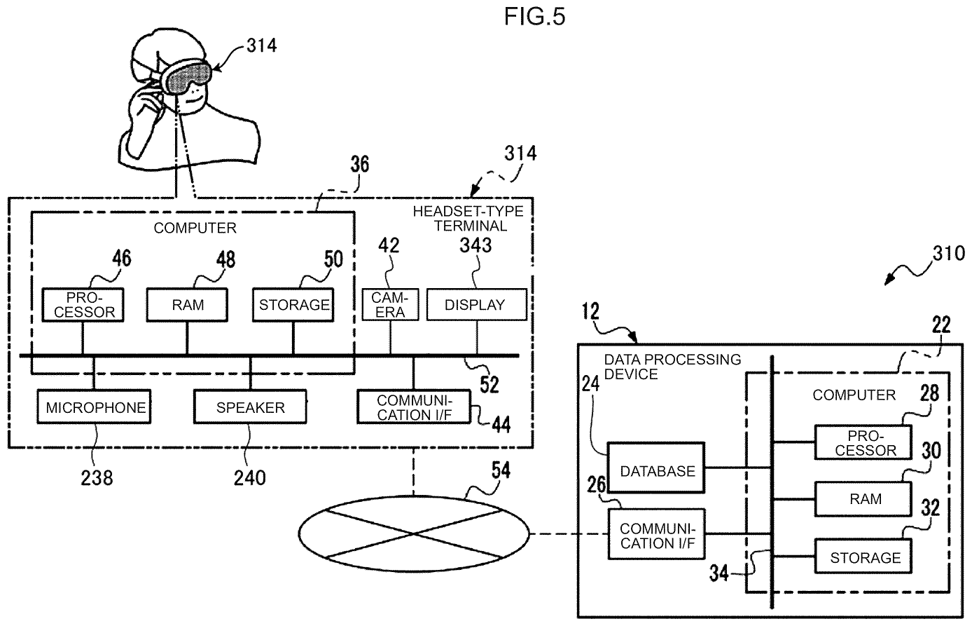

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

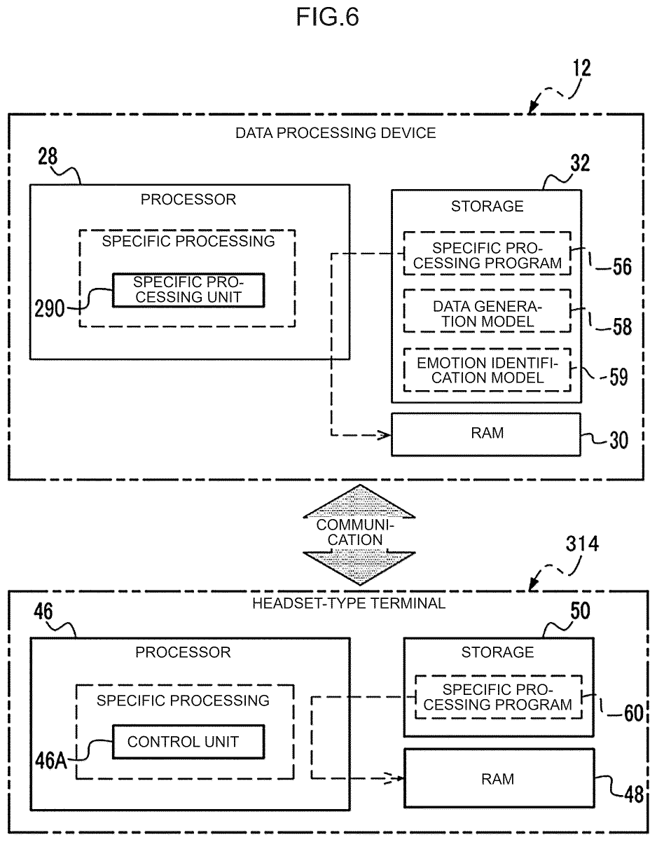

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described connection unit, startup unit, and operation unit is implemented by at least one of, for example, the headset-type terminal 314 and the data processing apparatus 12. For example, the connection unit connects a USB-type messenger application mobile terminal using the USB port of the headset-type terminal 314. The startup unit recognizes the terminal connected by the control unit 46A of the headset-type terminal 314 and launches the messenger application. The operation unit can operate the interface of the messenger application using the remote controller of the headset-type terminal 314. The correspondence between each unit and the device or control unit is not limited to the above examples and various modifications are possible.

### Fourth Embodiment

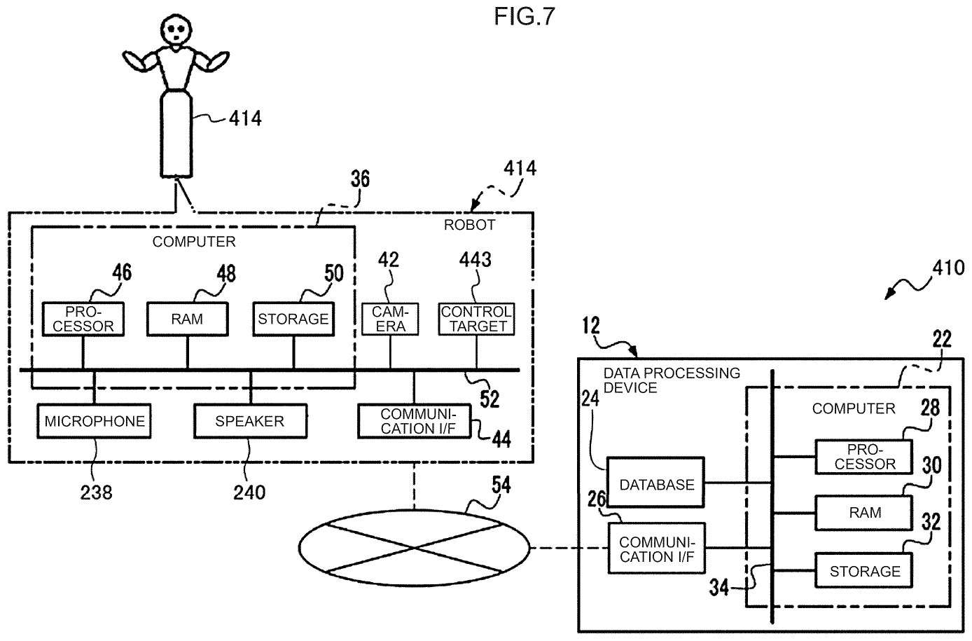

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

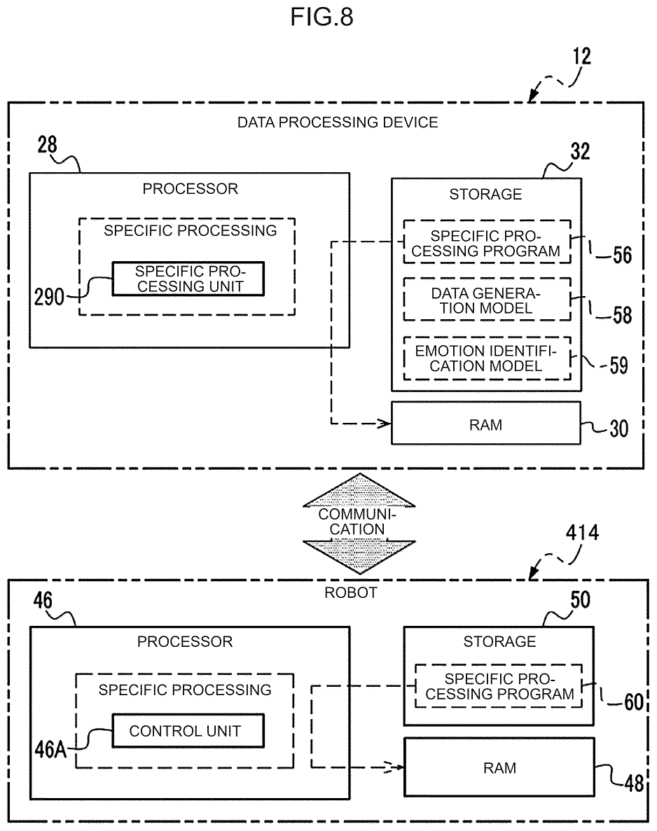

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described connection unit, startup unit, and operation unit is implemented by at least one of, for example, the robot 414 and the data processing apparatus 12. For example, the connection unit connects a USB-type messenger application mobile terminal using the USB port of the robot 414. The startup unit recognizes the terminal connected by the control unit 46A of the robot 414 and launches the messenger application. The operation unit can operate the interface of the messenger application using the remote controller of the robot 414. The correspondence between each unit and the device or control unit is not limited to the above examples and various modifications are possible.

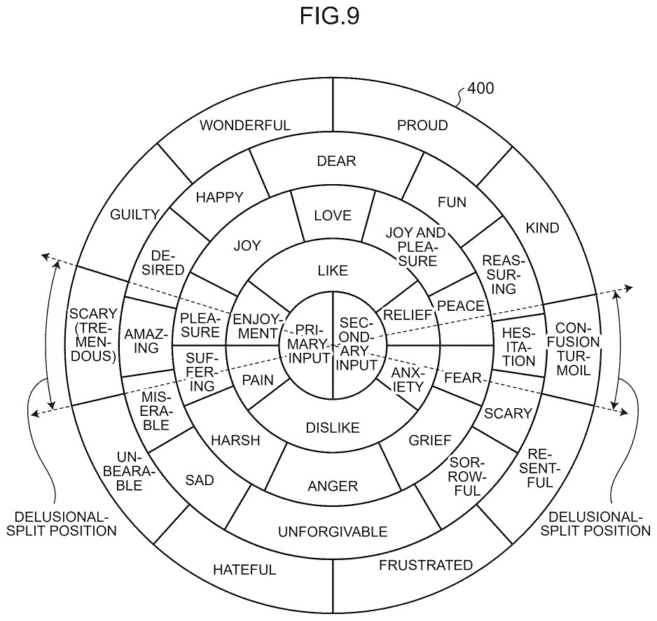

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

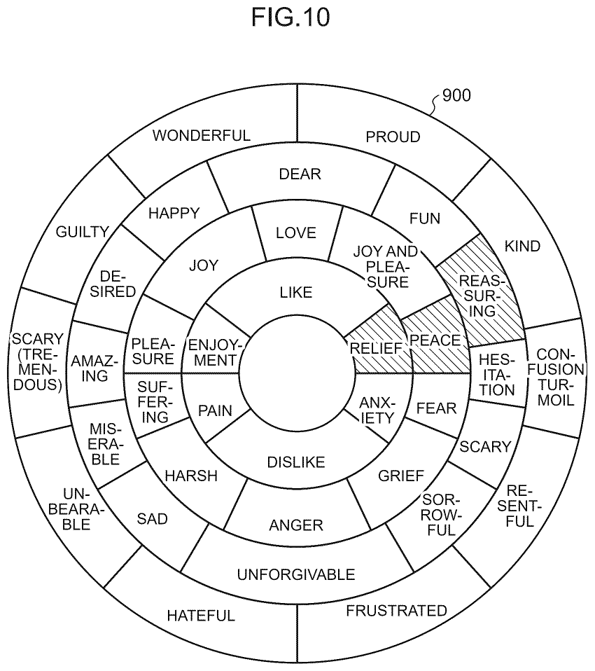

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a connection unit configured to connect a mobile terminal equipped with a USB-type messenger application to a USB port of a television; a startup unit configured to recognize the terminal connected by the connection unit and launch the messenger application; and an operation unit configured to operate the messenger application launched by the startup unit using a remote controller.
(Supplementary Note 2)The system according to Supplementary Note 1, wherein the operation unit is configured to send and receive messages.
(Supplementary Note 3)The system according to Supplementary Note 1, wherein the operation unit is configured to share photos or videos.
(Supplementary Note 4)The system according to Supplementary Note 1, wherein the operation unit is configured to perform video calls.
(Supplementary Note 5)The system according to Supplementary Note 1, wherein the operation unit is configured to display messages on a large television screen.
(Supplementary Note 6)The system according to Supplementary Note 1, wherein the operation unit is configured to allow family members or caregivers to regularly (for example, once a week) conduct video calls with elderly persons to confirm their safety and check their health status.
(Supplementary Note 7)The system according to Supplementary Note 1, wherein the connection unit is configured to estimate a user's emotion and adjust the timing of the connection based on the estimated emotion.
(Supplementary Note 8)The system according to Supplementary Note 1, wherein the connection unit is configured to detect the usage status of the television at the time of connection and select an appropriate connection timing.
(Supplementary Note 9)The system according to Supplementary Note 1, wherein the connection unit is configured to perform filtering to avoid interference with other connected devices of the television at the time of connection.
(Supplementary Note 10)The system according to Supplementary Note 1, wherein the connection unit is configured to estimate a user's emotion and determine the priority of the connection based on the estimated emotion.
(Supplementary Note 11)The system according to Supplementary Note 1, wherein the connection unit is configured to select an optimal connection method by considering the user's geographic location information at the time of connection.
(Supplementary Note 12)The system according to Supplementary Note 1, wherein the connection unit is configured to analyze the user's past connection history at the time of connection and propose an optimal connection method.
(Supplementary Note 13)The system according to Supplementary Note 1, wherein the startup unit is configured to estimate a user's emotion and adjust the timing of startup based on the estimated emotion.
(Supplementary Note 14)The system according to Supplementary Note 1, wherein the startup unit is configured to detect the usage status of the television at the time of startup and select an optimal startup timing.
(Supplementary Note 15)The system according to Supplementary Note 1, wherein the startup unit is configured to perform filtering to avoid interference with other applications of the television at the time of startup.
(Supplementary Note 16)The system according to Supplementary Note 1, wherein the startup unit is configured to estimate a user's emotion and determine the priority of startup based on the estimated emotion.
(Supplementary Note 17)The system according to Supplementary Note 1, wherein the startup unit is configured to select an optimal startup method by considering the user's geographic location information at the time of startup.
(Supplementary Note 18)The system according to Supplementary Note 1, wherein the startup unit is configured to analyze the user's past startup history at the time of startup and propose an optimal startup method.
(Supplementary Note 19)The system according to Supplementary Note 1, wherein the operation unit is configured to estimate a user's emotion and adjust the operation interface based on the estimated emotion.
(Supplementary Note 20)The system according to Supplementary Note 1, wherein the operation unit is configured to refer to the user's past operation history at the time of operation and propose an optimal operation method.
(Supplementary Note 21)The system according to Supplementary Note 1, wherein the operation unit is configured to customize the operation procedure based on the user's current usage status at the time of operation.
(Supplementary Note 22)The system according to Supplementary Note 1, wherein the operation unit is configured to estimate a user's emotion and determine the priority of operation based on the estimated emotion.
(Supplementary Note 23)The system according to Supplementary Note 1, wherein the operation unit is configured to select an optimal operation method by considering the user's geographic location information at the time of operation.
(Supplementary Note 24)The system according to Supplementary Note 1, wherein the operation unit is configured to analyze the user's social media activity at the time of operation and propose a relevant operation method.
(Supplementary Note 25)The system according to Supplementary Note 1, wherein the operation unit is configured to estimate a user's emotion and adjust the timing of message transmission based on the estimated emotion.
(Supplementary Note 26)The system according to Supplementary Note 1, wherein the operation unit is configured to refer to the user's past message history at the time of sending and receiving messages and propose an optimal transmission method.
(Supplementary Note 27)The system according to Supplementary Note 1, wherein the operation unit is configured to estimate a user's emotion and adjust the timing of sharing photos or videos based on the estimated emotion.
(Supplementary Note 28)The system according to Supplementary Note 1, wherein the operation unit is configured to refer to the user's past sharing history at the time of sharing photos or videos and propose an optimal sharing method.
(Supplementary Note 29)The system according to Supplementary Note 1, wherein the operation unit is configured to estimate a user's emotion and adjust the timing of starting a video call based on the estimated emotion.
(Supplementary Note 30)The system according to Supplementary Note 1, wherein the operation unit is configured to refer to the user's past call history at the time of video calls and propose an optimal call method.
(Supplementary Note 31)The system according to Supplementary Note 1, wherein the operation unit is configured to estimate a user's emotion and adjust the message display method based on the estimated emotion.
(Supplementary Note 32)The system according to Supplementary Note 1, wherein the operation unit is configured to refer to the user's past display history at the time of message display and propose an optimal display method.
(Supplementary Note 33)The system according to Supplementary Note 1, wherein the operation unit is configured to estimate a user's emotion and adjust the timing of confirming safety or checking health status based on the estimated emotion.
(Supplementary Note 34)The system according to Supplementary Note 1, wherein the operation unit is configured to refer to the user's past health data at the time of confirming safety or checking health status and propose an optimal checking method.

What is claimed is:

1. A system comprising:
a communication interface configured to communicate with a client terminal via a packet-switched network;
a memory storing a data generation model obtained by deep learning on a neural network, and an emotion identification model; and
circuitry configured to:
receive, from the client terminal via the communication interface, device identification data comprising a vendor identifier, a product identifier, and
application signature data associated with a removable storage device connected to the client terminal;
determine, based on the device identification data, that the removable storage device stores a messenger application by verifying the application signature data using a signature verification algorithm;
transmit, to the client terminal via the communication interface, application launch data causing the client terminal to load executable files and resource files of the messenger application from the removable storage device into a memory of the client terminal and to render a user interface of the messenger application on a display of the client terminal;
receive, from the client terminal via the communication interface, sensor data comprising at least one of voice data captured by a microphone of the client terminal or image data captured by a camera of the client terminal;
estimate an emotion of a user by applying the emotion identification model to the sensor data to generate an emotion label and an emotion score;
adjust at least one of a user interface parameter or an operation timing of the messenger application based on the estimated emotion; and
transmit, to the client terminal via the communication interface, interface rendering data causing the client terminal to update the user interface according to the adjusted user interface parameter.

2. The system according to claim 1, wherein the removable storage device comprises a USB storage device, and wherein the device identification data further comprises file system structure data comprising at least one of FAT32 or exFAT format data.

3. The system according to claim 1, wherein the signature verification algorithm comprises at least one of RSA signature verification or ECDSA signature verification, and wherein the application signature data comprises a SHA-256 hash value.

4. The system according to claim 1, wherein the circuitry is further configured to transmit, to the client terminal via the communication interface, remote controller mapping data associating input signals from a remote controller of the client terminal with functions of the messenger application.

5. The system according to claim 1, wherein the messenger application functions comprise at least one of message sending and receiving, photo or video sharing, or video calling using a WebRTC protocol.

6. The system according to claim 1, wherein the circuitry is further configured to adjust the user interface parameter based on the estimated emotion, such that when the emotion label indicates nervousness, the interface rendering data comprises a calm color scheme, and when the emotion label indicates enjoyment, the interface rendering data comprises a bright color scheme.

7. The system according to claim 1, wherein the circuitry is further configured to adjust the operation timing based on the estimated emotion, such that when the emotion label indicates relaxation, the circuitry delays transmission of data, and when the emotion label indicates urgency, the circuitry transmits data immediately.

8. The system according to claim 1, wherein the emotion identification model comprises at least one of a convolutional neural network for facial expression recognition, a recurrent neural network for voice emotion recognition, or a Transformer-based multimodal fusion network.

9. The system according to claim 1, wherein the circuitry is further configured to detect a usage status of the client terminal comprising at least one of a power state, an input source type, or a recording process status, and to adjust the application launch data based on the detected usage status.

10. The system according to claim 1, wherein the circuitry is further configured to receive, from the client terminal via the communication interface, geographic location information of the user, and to select an optimal network connection method based on the geographic location information.

11. The system according to claim 1, wherein the circuitry is further configured to analyze past connection history data stored in a database to determine an optimal connection timing, the past connection history data comprising connection date and time data, connection method data, and success or failure flag data.

12. The system according to claim 1, wherein the circuitry is further configured to detect interference with other connected devices by monitoring at least one of USB port connection status, HDMI port connection status, or Wi-Fi and Bluetooth channel usage status, and to perform filtering to avoid the detected interference.

13. The system according to claim 1, wherein the circuitry is further configured to determine a priority of the application launch data based on the estimated emotion, such that when the emotion label indicates stress, the circuitry assigns a high priority, and when the emotion label indicates relaxation, the circuitry assigns a low priority.

14. The system according to claim 1, wherein the circuitry is further configured to analyze past operation history data of the user stored in a database, and to propose an optimal operation method based on the past operation history data, the past operation history data comprising operation date and time data, operation type data, and success rate data.

15. The system according to claim 1, wherein the circuitry is further configured to receive, from the client terminal via the communication interface, social media activity data of the user, analyze the social media activity data using a natural language processing model to extract activity patterns, and adjust the user interface parameter based on the extracted activity patterns.

16. The system according to claim 1, wherein the circuitry is further configured to schedule periodic transmission of video call initiation data to the client terminal, and to transmit health status checking data during the video call.

17. The system according to claim 1, wherein the interface rendering data comprises at least one of font size adjustment data, contrast enhancement data, or layout simplification data for accessibility optimization.

18. A system comprising:
a communication interface configured to communicate, via a packet-switched network conforming to at least one of a 5G, Wi-Fi, or Bluetooth communication standard, with a client terminal comprising a display, a microphone, a speaker, a camera having a CMOS image sensor, and a USB port;
a processor;
a random-access memory;
a memory storing a data generation model obtained by deep learning on a neural network, and an emotion identification model;
a database; and
circuitry configured to:
receive, from the client terminal via the communication interface, device identification data comprising a vendor identifier, a product identifier, file system structure data, and application signature data associated with a USB storage device connected to the USB port of the client terminal;
determine, based on the device identification data, that the USB storage device stores a messenger application by verifying the application signature data using at least one of RSA signature verification or ECDSA signature verification;
transmit, to the client terminal via the communication interface, application launch data causing the client terminal to load executable files and resource files of the messenger application from the USB storage device and to render a user interface of the messenger application on the display;
receive, from the client terminal via the communication interface, sensor data comprising at least one of voice data captured by the microphone or image data captured by the camera;
estimate an emotion of a user by applying the emotion identification model to the sensor data to generate an emotion label and an emotion score;
adjust at least one of a user interface parameter, an operation timing, or a priority based on the estimated emotion;
store the emotion label and the emotion score in the database; and
transmit, to the client terminal via the communication interface, interface rendering data causing the client terminal to update the user interface according to the adjusted user interface parameter.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network and an emotion identification model, the method comprising:
receiving, from a client terminal via the communication interface and a packet-switched network, device identification data comprising a vendor identifier, a product identifier, and application signature data associated with a removable storage device connected to the client terminal;
determining, based on the device identification data, that the removable storage device stores a messenger application by verifying the application signature data using a signature verification algorithm;
transmitting, to the client terminal via the communication interface, application launch data causing the client terminal to load executable files and resource files of the messenger application from the removable storage device into a memory of the client terminal and to render a user interface of the messenger application on a display of the client terminal;
receiving, from the client terminal via the communication interface, sensor data comprising at least one of voice data captured by a microphone of the client terminal or image data captured by a camera of the client terminal;
estimating an emotion of a user by applying the emotion identification model to the sensor data to generate an emotion label and an emotion score;
adjusting at least one of a user interface parameter or an operation timing of the messenger application based on the estimated emotion; and
transmitting, to the client terminal via the communication interface, interface rendering data causing the client terminal to update the user interface according to the adjusted user interface parameter.
